(19) United States
(12) Patent Application Publication
(10) Pub. No.: US 2025/0007583 A1
(43) Pub. Date: Jan. 2, 2025

(54) INFORMATION FEEDBACK METHOD AND APPARATUS AND STORAGE MEDIUM

(71) Applicant: Beijing Xiaomi Mobile Software Co., Ltd., Beijing (CN)

(72) Inventors: Liangang CHI, Beijing (CN); Dong CHEN, Beijing (CN)

(73) Assignee: Beijing Xiaomi Mobile Software Co., Ltd., Beijing (CN)

(21) Appl. No.: 18/707,010

(22) PCT Filed: Nov. 3, 2021
(86) PCT No.: PCT/CN2021/128380

§ 371 Date: May 2, 2024

(51) Int. Cl. H04B 7/06

(52) U.S. Cl. CPC H04B 7/0626; H04B 7/063; H04B 7/0658

(57) ABSTRACT

An information feedback method and apparatus that improve communication in a wireless communication network. The communication in the wireless communication network is improved by: determining a first channel state information (CSI) matrix, the first CSI matrix being a matrix used for indicating different angle values corresponding to different feedback paths when a terminal feeds CSI by an antenna back to a base station; obtaining a first correlation feature matrix outputted from the a multi-feature analysis network and used for indicating a correlation among a plurality of feature information of the CSI by inputting the first CSI matrix into the first multi-feature analysis network; obtaining a target codeword corresponding to the CSI by compressing the first correlation feature matrix; and feeding the target codeword back to the base station by the antenna.

### CROSS REFERENCE TO RELATED APPLICATION

The present application is a U.S. National Stage of International Application No. PCT/CN2021/128380, filed on Nov. 3, 2021, the contents of all of which are incorporated herein by reference in their entirety for all purposes.

### BACKGROUND OF THE INVENTION

An m-MIMO (massive Multiple-input Multiple-output) technology has become an essential component of a 5G (5th Generation Mobile Communication Technology) wireless network due to its efficient spectral performance. However, to fully utilize the technology, accurate CSI (Channel State Information) needs to be obtained at a transmitter.

### SUMMARY OF THE INVENTION

According to a first aspect of the examples of the disclosure, an information feedback method is provided. The method is performed by a terminal and includes:
determining a first channel state information (CSI) matrix, the first CSI matrix being a matrix used for indicating different angle values corresponding to different feedback paths when a terminal feeds CSI by an antenna back to a base station;
obtaining a first correlation feature matrix outputted from a first multi-feature analysis network and used for indicating a correlation among a plurality of pieces of feature information of the CSI by inputting the first CSI matrix into the first multi-feature analysis network;
obtaining a target codeword corresponding to the CSI by compressing the first correlation feature matrix; and
feeding the target codeword back to the base station by the antenna.

According to a second aspect of the examples of the disclosure, an information feedback method is provided. The method is performed by a base station and includes:
receiving a target codeword corresponding to channel state information (CSI) and fed back by a terminal;
recovering the target codeword to a second correlation feature matrix having the same dimension as a first correlation feature matrix, the first correlation feature matrix being a matrix used for indicating a correlation among a plurality of pieces of feature information of the CSI; and
determining a target CSI matrix based on an output result of a second multi-feature analysis network by inputting the second correlation feature matrix into the second multi-feature analysis network;
where the target CSI matrix is a matrix, determined by the base station, of different angle values corresponding to different feedback paths when the terminal feeds the CSI by an antenna back to the base station.

According to a third aspect of the examples of the disclosure, a non-transitory computer readable storage medium is provided. The storage medium stores a computer program, and the computer program is used for executing any above information feedback method at a terminal side.

According to a fourth aspect of the examples of the disclosure, a non-transitory computer readable storage medium is provided. The storage medium stores a computer program, and the computer program is used to execute any above information feedback method on the base station side.

According to a fifth aspect of the examples of the disclosure, an information feedback apparatus is provided, including:
a processor; and
a memory, configured to store a processor-executable instruction,
where the processor is configured to execute any above information feedback method at a terminal side.

According to a sixth aspect of the examples of the disclosure, an information feedback apparatus is provided, including:
a processor; and
a memory, configured to store a processor-executable instruction,
where the processor is configured to execute any above information feedback method at a base station side.

It is to be understood that above general descriptions and later detailed descriptions are merely examples and illustrative, and cannot limit the disclosure.

### BRIEF DESCRIPTION OF DRAWINGS

Accompanying drawings here are incorporated into the specification, constitute a part of the specification, show examples consistent with the disclosure, and are used for explaining a principle of the disclosure together with the specification.

FIG. 1 is a schematic diagram of a network structure of a CSI compression feedback encoder and decoder in the related art illustrated according to an example.

FIG. 2 is a schematic flowchart of an information feedback method illustrated according to an example.

FIG. 3 is a schematic flowchart of another information feedback method illustrated according to an example.

FIG. 4 is a schematic flowchart of another information feedback method illustrated according to an example.

FIG. 5 is a schematic structural diagram of a spatial feature mining module illustrated according to an example.

FIG. 6 is a schematic structural diagram of a channel feature mining module illustrated according to an example.

FIG. 7 is a schematic flowchart of another information feedback method illustrated according to an example.

FIG. 8 is a schematic flowchart of another information feedback method illustrated according to an example.

FIG. 9A is a schematic diagram of a deployment of antennas at a base station illustrated according to an example.

FIG. 9B is a schematic flowchart of another information feedback method illustrated according to an example.

FIG. 10 is a schematic flowchart of another information feedback method illustrated according to an example.

FIG. 11 is a schematic diagram of a training process illustrated according to an example.

FIG. 12 is a schematic diagram of an information feedback interaction process illustrated according to an example.

FIG. 13 is a schematic structural diagram of a target encoding neural network and a target decoding neural network illustrated according to an example.

FIG. 14A is a schematic structural diagram of a target encoding neural network illustrated according to an example.

FIG. 14B is a schematic structural diagram of a target decoding neural network illustrated according to an example.

FIG. 14C is a schematic diagram of a network structure of a first multi-feature analysis network or a second multi-feature analysis network illustrated according to an example.

FIG. 15 is a block diagram of an information feedback apparatus illustrated according to an example.

FIG. 16 is a block diagram of another information feedback apparatus illustrated according to an example.

FIG. 17 is a schematic structural diagram of an information feedback apparatus illustrated according to an example of the disclosure.

FIG. 18 is a schematic structural diagram of another information feedback apparatus illustrated according to an example of the disclosure.

### DETAILED DESCRIPTION OF THE INVENTION

Examples will be illustrated in detail here, and their instances are shown in accompanying drawings. When the following description refers to the accompanying drawings, unless otherwise indicated, the same numbers in different accompanying drawings indicate the same or similar elements. Implementations described in the following examples do not represent all implementations consistent with the disclosure. Rather, they are merely instances of apparatuses and methods consistent with some aspects of the disclosure as detailed in the appended claims.

Terms used in the disclosure are merely for the purpose of describing specific examples, and not intended to limit the disclosure. “One,” “said,” and “the” of singular forms used in the disclosure and the appended claims are also intended to include plural forms unless the context clearly indicates other meanings. It is also to be understood that a term “and/or” as used here refers to and includes any or all possible combinations of least one associated listed item.

It is to be understood that although terms first, second, third, etc. may be used to describe various pieces of information in the disclosure, such information is not to be limited to these terms. These terms are merely used for distinguishing the same type of information from each other. For example, without departing from the scope of the disclosure, first information may also be referred to as second information, and similarly, the second information may also be referred to as the first information. Depending on the context, for example, a word “if” as used here may be interpreted as “at the time,” “when,” or “in response to determining”.

In an FDD (Frequency Division Duplex) system, CSI of a downlink is usually estimated at a terminal and then is fed back to a base station by a feedback link. However, due to a large number of antennas, a channel matrix in an m-MIMO system is very large, which makes CSI estimation and feedback very challenging, especially through a bandwidth-constrained feedback channel.

Currently, CSI feedback may be performed by adopting a feedback manner based on compressive sensing (CS), and the method includes the following steps 1-2.

Step 1, a low-dimensional measured value is obtained by transforming CSI to a sparse matrix under a specified basis, and randomly compressing and sampling the CSI at a terminal side by using a compressive sensing method, and is transmitted to a base station through a feedback link.

The basis refers to a unit of the sparse matrix.

Step 2, the base station adopts a compressive sensing manner to recover an original sparse CSI matrix from the received low-dimensional measured value.

But the CS-based feedback manner for CSI feedback needs that the CSI is a fully sparse matrix on some bases, however, the CSI matrix is merely approximately a sparse matrix and not a fully-sparse sparse matrix. In addition, there is a need to use a random projection manner, and a CSI structure is not fully utilized. The CS-based feedback manner for the CSI feedback involves an iterative algorithm, and reconstruction of the CSI matrix needs to consume a lot of time.

In order to solve the above technical problems, a CSI feedback manner based on deep learning (DL) may be adopted. The CSI feedback manner based on DL may include the following steps 1-5.

Step 1, a CSI matrix corresponding to an angular domain is obtained at the terminal side by performing a two-dimensional discrete Fourier transform (DFT) on a CSI matrix determined based on parameter values of space domains and frequency domains of the CSI, and a channel matrix H, which is one dimension higher than an angular-domain CSI matrix, is obtained by respectively taking out a real portion and an imaginary portion of the angular-domain CSI matrix for stacking.

Step 2, a neural network model including an encoder and a decoder is constructed, where the encoder is deployed at the terminal side to encode the channel matrix H into lower-dimensional codewords, and the decoder is deployed at the base station side to reconstruct an estimated value Ĥ of an original angular-domain CSI matrix from the lower-dimensional codewords.

Step 3, the neural network model is trained off-line, so that the estimated value A is as close as possible to the original angular-domain matrix H, and network parameters corresponding to the model are obtained.

Step 4, reconstructed values of the CSI matrix corresponding to the space domains and the frequency domains are obtained by performing a two-dimensional inverse DFT on the estimated value R outputted from the model.

Step 5, the trained neural network model is applied to the terminal and the base station.

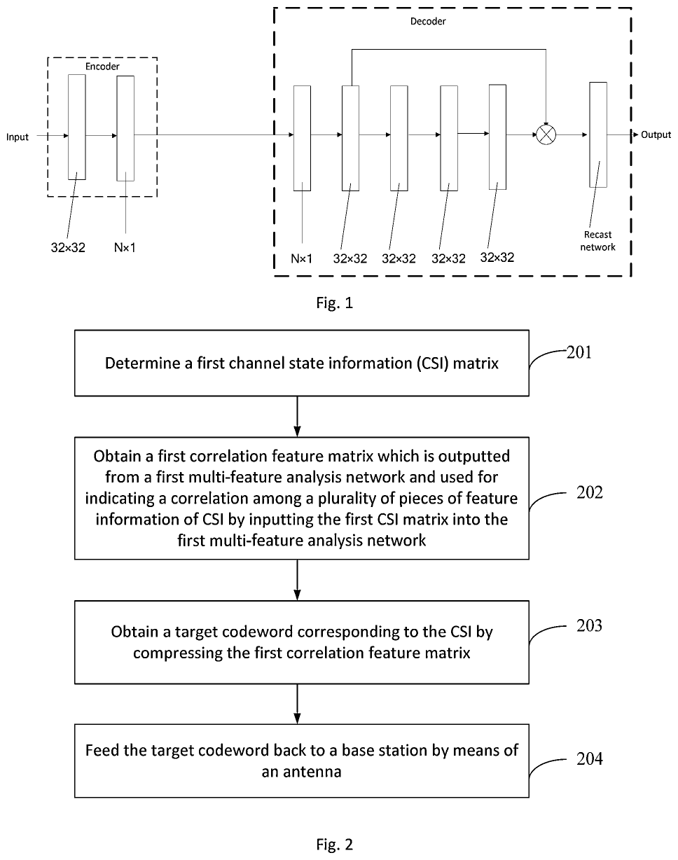

However, in the above manner, CSI compression feedback networks are based on convolutional neural networks to extract space domain features, which cannot fully utilize the CSI structure and has poor performance gain. In addition, the CSI compression feedback networks are monotonous in structure, a network structure of a CSI compression feedback encoder and decoder in the related art may refer to FIG. 1, and the recovery precision is poor.

In order to solve the above technical problems, the disclosure provides an information feedback method and apparatus and a storage medium, relating to the field of communication.

Through the information feedback method, the CSI structure can be fully utilized, CSI feedback is performed based on a correlation among feature information of a plurality of dimensions, such that the precision of compression feedback is improved, and the accuracy of CSI reconstruction by the base station side is improved.

The information feedback method provided by the disclosure is described below first from the terminal side.

An example of the disclosure provides an information feedback method, as shown with reference to FIG. 2, which is a flowchart of an information feedback method illustrated according to an example. The information feedback method may be used at a terminal, on which a single antenna may be configured. The corresponding number of subcarriers during communicating with a base station side is a specified number, which has been configured prior to shipment of the terminal from the factory. The method may include the following steps 201-204.

In step 201, a first channel state information (CSI) matrix is determined.

In the example of the disclosure, the first CSI matrix is a matrix used for indicating different angle values corresponding to different feedback paths when the terminal feeds CSI by an antenna back to a base station. The first CSI matrix may include different angle values corresponding to different delays in the arrival of the CSI at the base station on different feedback paths when the terminal feeds the CSI by the antenna back to the base station.

In step 202, a first correlation feature matrix outputted from a first multi-feature analysis network and used for indicating a correlation among a plurality of pieces of feature information of the CSI is obtained by inputting the first CSI matrix into the first multi-feature analysis network.

In the example of the disclosure, the first multi-feature analysis network is a neural network that has been pre-trained to determine the first correlation feature matrix. In a possible implementation, the plurality of pieces of feature information of the CSI include but are not limited to spatial feature information of the CSI and channel feature information of the CSI.

In step 203, a target codeword corresponding to the CSI is obtained by compressing the first correlation feature matrix.

Considering that the terminal generally feeds a CSI vector back to the base station, thus, in the disclosure, the first correlation feature matrix may first be subjected to a dimensionality reduction to be converted to a first correlation feature vector, and furthermore, the target codeword is obtained after compressing the first correlation feature vector by a preset compression rate.

In step 204, the target codeword is fed back to the base station by the antenna.

In the example of the disclosure, the terminal may feed the target codeword back to the base station by its own antenna.

In the above example, the CSI structure can be fully utilized, and CSI feedback is performed based on the correlation among the feature information of a plurality of dimensions, such that the precision of compression feedback is improved.

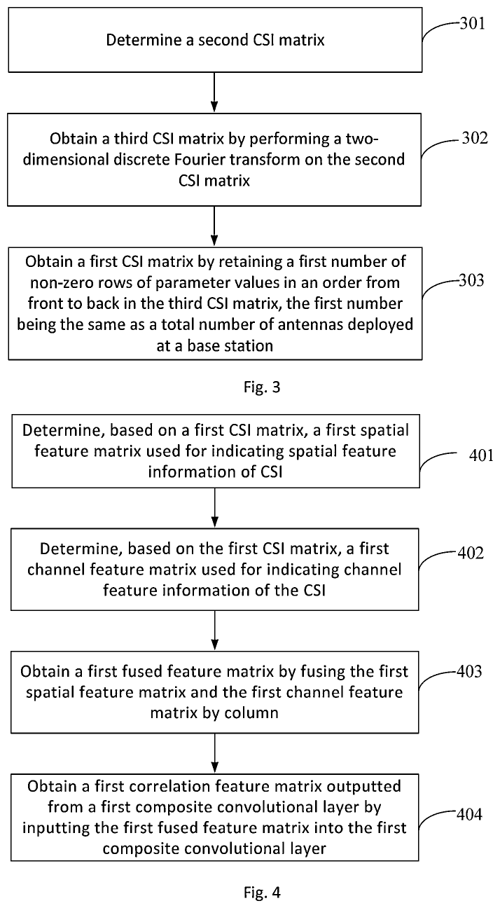

In some examples, as shown with reference to FIG. 3, FIG. 3 is a flowchart of an information feedback method illustrated according to an example. The information feedback method may be used at the terminal, on which the single antenna may be configured. The corresponding number of the subcarriers during communicating with the base station side is the specified number, which has been configured prior to shipment of the terminal from the factory. The method may include the following steps 301-303.

In step 301, a second CSI matrix is determined.

In the example of the disclosure, the second CSI matrix is a matrix used for indicating different parameter values corresponding to different space domains and frequency domains when the terminal feeds the CSI by the antenna back to the base station. The second CSI matrix may be represented by Ĥ.

In step 302, a third CSI matrix is obtained by performing a two-dimensional discrete Fourier transform on the second CSI matrix.

In the example of the disclosure, the third CSI matrix Ha may be determined by adopting the following formula 1:

$${H}_{a} = {F}_{a} \tilde{H} {F}_{b}^{H} \qquad formula 1$$

where Ĥ is the second CSI matrix, Fₐ and F_{b} are DFT matrices of a size N_{c}×N_{c} and a size f×f respectively, a superscript H denotes a conjugate transpose of the matrix, N_{c} is the specified number of the subcarriers adopted by the terminal, f is the total number of antennas deployed at the base station side, and f is a positive integer, which may be set as needed.

In step 303, the first CSI matrix is obtained by retaining a first number of non-zero rows of parameter values in an order from front to back in the third CSI matrix, and the first number is the same as the total number of the antennas deployed at the base station.

In the example of the disclosure, since Ha contains the first f non-zero rows of parameter values, in order to facilitate the subsequent compression, a non-zero principal value of Ha may be retained, i.e., a first number of non-zero rows of parameter values are retained in the third CSI matrix Ha in the order from front to back, the first number here is the same as the total number f of the antennas deployed at the base station, the first CSI matrix H is obtained, and the size of the first CSI matrix H is f×f.

In the example of the disclosure, the above steps 301 to 303 may be deployed alone or in combination with the above steps 202 to 204, which is not limited by the disclosure.

In the above example, the second matrix used for indicating different parameter values corresponding to different space domains and frequency domains when the terminal feeds the CSI back to the base station by the antenna may be first determined. Further, the third CSI matrix is obtained after performing the two-dimensional discrete Fourier transform based on the second matrix, and the first CSI matrix is obtained by retaining the first number of non-zero rows of parameter values for the third CSI matrix in the order from front to back. In the disclosure, a parameter value with a value of zero is deleted from the third CSI matrix, so that the first CSI matrix may better feed back the different angle values corresponding to different feedback paths when the terminal feeds the CSI to the base station by the antenna, which facilitates subsequent encoding and compression, is easy to implement and has high usability.

In some examples, the plurality of pieces of feature information of the CSI at least include spatial feature information of the CSI and channel feature information of the CSI.

As shown with reference to FIG. 4, FIG. 4 is a flowchart of an information feedback method illustrated according to an example. The information feedback method may be used at the terminal, on which the single antenna may be configured. The corresponding number of the subcarriers during communicating with the base station side is the specified number, which has been configured prior to shipment of the terminal from the factory. The first multi-feature analysis network is deployed on the terminal, and a process of determining the first correlation feature matrix by the first multi-feature analysis network may include the following steps 401-404.

In step 401, based on the first CSI matrix, a first spatial feature matrix used for indicating the spatial feature information of the CSI is determined.

In the example of the disclosure, the first multi-feature analysis network may input a real portion Hᵣₑ and an imaginary portion Hᵢₘ of the first CSI matrix into a spatial feature mining module, and the first spatial feature matrix is obtained through the spatial feature mining module. Sizes of Hᵣₑ and Hᵢₘ are both 1×f×f.

In step 402, based on the first CSI matrix, a first channel feature matrix used for indicating the channel feature information of the CSI is determined.

In the example of the disclosure, the first multi-feature analysis network may input the real portion Hᵣₑ and the imaginary portion Hᵢₘ of the first CSI matrix into a channel feature mining module, and the first channel feature matrix is obtained through the channel feature mining module. Sizes of Hᵣₑ and Hᵢₘ are both 1×f×f.

In step 403, a first fused feature matrix is obtained by fusing the first spatial feature matrix and the first channel feature matrix by column.

In the example of the disclosure, the first spatial feature matrix and the first channel feature matrix above may be fused by column through a fusion learning module of the first multi-feature analysis network, and dimensions of the fused first fused feature matrix are 2c×f×f.

In step 404, the first correlation feature matrix outputted from a first composite convolutional layer is obtained by inputting the first fused feature matrix into the first composite convolutional layer.

In the example of the disclosure, the first composite convolutional layer is obtained by compositing a first convolutional layer with at least one other neural network layer. A size of convolutional kernels of the first convolutional layer is 1×1, and the number of the convolutional kernels of the first convolutional layer is the same as the number c of channels inputted into the first composite convolutional layer. The number c of the channels is a positive integer and may be set as needed. In the disclosure, c may be 2. The at least one other neural network layer includes, but is not limited to, a batch normalization layer and an activation function layer.

The role of the convolutional layer is to extract feature information of an input parameter, the role of the batch normalization layer is to learn the distribution information of data, and the role of the activation function layer is to complete mapping from the input parameter to an output parameter. In the example of the disclosure, the size of the convolution kernels of the first convolutional layer is 1×1, and the number of the convolution kernels of the first convolutional layer is the same as the number c of the channels inputted into the first composite convolutional layer. The first composite convolutional layer obtained by combining the batch normalization layer and the activation function layer may learn a correlation of direct features of different dimensions in the first fused feature matrix, and the learning performance is improved, thus improving the representation capability of the first multi-feature analysis network. Unified learning of feature information in different dimensions through the first composite convolutional layer makes a difference between CSI matrix features more clear, elements that play a dominant role are strengthened, and redundant elements are weakened, so that compression is conductive to recasting.

In the above example, the first CSI matrix used for indicating the correlation among feature information of the plurality of dimensions may be determined by fully utilizing the CSI structure through the first multi-feature analysis network deployed on the terminal based on the inputted first CSI matrix. The precision of the compression feedback is improved, allowing the terminal side to extract more CSI feature information.

In some examples, the spatial feature mining module of the first multi-feature analysis network may consist of a second number of second composite convolutional layers, and each of the second composite convolutional layers is obtained by compositing the second convolutional layer with at least one other neural network layer, where the at least one other neural network layer includes, but is not limited to, a batch normalization layer and an activation function layer.

In order to better mine the spatial features of the CSI, the second number of second composite convolutional layers of the spatial feature mining module may include at least two second convolutional layers with convolutional kernels of different sizes.

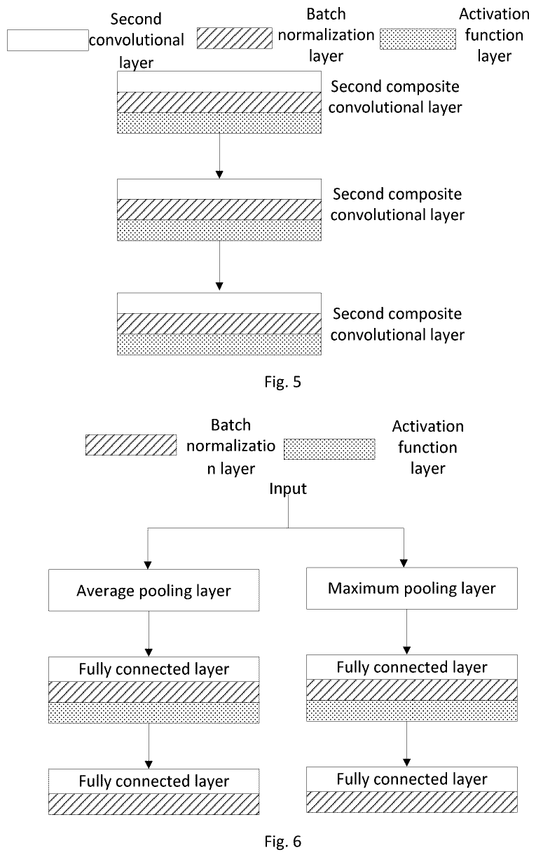

Referring to FIG. 5, the second number may be a positive integer greater than 2. The second number in FIG. 5 is 3. The sizes of the convolutional kernels of the three second convolutional layers are m×m, 1×n and n×1 respectively, and the number c of the convolutional kernels of each second convolutional layer is the same as the number of channels inputted into each second composite convolutional layer, where c is 2.

In the example of the disclosure, for better mining spatial features, m<n may be set, and m and n are both positive integers. In addition, more feature information is mined by alternating second convolutional layers with convolutional kernels of sizes 1×n and n×1 compared to the second convolutional layer with the convolutional kernel of the size n×n.

The first spatial feature matrix outputted from the second number of second composite convolutional layers is obtained by inputting the real portion Hᵣₑ and the imaginary portion Hᵢₘ of the first CSI matrix into the second number of second composite convolutional layers.

In the above example, the spatial feature information of the CSI may be mined quickly, with easy implementation and high usability.

In some examples, the channel feature mining module of the first multi-feature analysis network may consist of two parts.

Referring to FIG. 6, a first part of the channel feature mining module includes a first composite layer, and the first composite layer is obtained by at least compositing an average pooling layer with a third number of first fully connected layers. The third number may be a positive integer, and the third number in FIG. 6 is 2. The first composite layer may also include a batch normalization layer and an activation function layer. The first composite layer may mine an average global channel feature of the CSI. The first feature matrix outputted from the first composite layer may be obtained by inputting the real portion Hᵣₑ and the imaginary portion Hᵢₘ of the first CSI matrix into the first composite layer. The first feature matrix is used for indicating the average global channel feature information of the CSI.

A second part of the channel feature mining module includes a second composite layer, and the second composite layer is obtained by at least compositing a maximum pooling layer with a third number of second fully connected layers. The third number may be a positive integer, and the third number in FIG. 6 is 2. The second composite layer may also include a batch normalization layer and an activation function layer. The second composite layer may mine a maximum global channel feature of the CSI. The second feature matrix outputted from the second composite layer may be obtained by inputting the real portion Hᵣₑ and the imaginary portion Hᵢₘ of the first CSI matrix into the second composite layer. The second feature matrix is used for indicating the maximum global channel feature information of the CSI.

In the example of the disclosure, the real portion Hᵣₑ and the imaginary portion Hᵢₘ of the first CSI matrix are inputted into the first part and the second part, where Hᵣₑ and Hᵢₘ are both of a size 1×f×f, and the dimension of the inputted CSI matrix is then c×f×f in the case of jointly inputting the first part and the second part, where c is 2. After passing through the average pooling layer or the maximum pooling layer, the dimension is c×1×1. The dimension of the first fully connected layer in FIG. 6 may be

$$c \times \frac{c}{r} ,$$

and the dimension of the last fully connected layer is l×c, where

$$r < c , \frac{c}{r}$$

is a positive integer, l is the input dimension of the last fully connected layer, and r and l are positive integers, which may be set as needed.

Network parameters corresponding to the third number of first fully connected layers and network parameters corresponding to the third number of second fully connected layers in the first and second parts of the channel feature mining module are the same. The network parameters may be reduced while improving performance.

After obtaining the above first feature matrix and second feature matrix through the first part and the second part of the channel feature mining module respectively, a fused third feature matrix X may be determined by performing a weighted fusion on the first feature matrix and the second feature matrix with the following formula 2:

$$X = {W}_{1} {X}_{1} + {W}_{2} {X}_{2} \qquad formula 2$$

where X₁ is the first feature matrix, X₂ is the second feature matrix, W₁ is a weight value corresponding to the first feature matrix, W₂ is a weight value corresponding to the second feature matrix, and initial values of W₁ and W₂ may be 1, which may be subsequently updated by the learning process of the neural network.

In the example of the disclosure, the third feature matrix represents the fused channel feature information, and it is also needed to dot-multiply the fused third feature matrix and the first CSI matrix H to determine the first channel feature matrix. The first channel feature matrix differs from the first CSI matrix H. The first channel feature matrix enhances features with a large amount of information and suppresses useless features, which is conductive to decompression and recasting after compression.

In the above example, the channel feature information of the CSI may be mined quickly, with easy implementation and high usability. The features with the large amount of information are enhanced, and the useless features are suppressed, which is conductive to decompression and recasting after compression.

In some examples, after the first correlation feature matrix is determined at the terminal side, a target codeword corresponding to the CSI may be obtained through the compression performed by a compression neural network.

The compression neural network may include a reconstruction layer and a dimensionality reduction fully connected layer, a dimensionality reduction is performed on the first correlation feature matrix through the reconstruction layer, the dimension of the first correlation feature matrix is c×f×f, and the dimension of the first correlation feature vector obtained through the reconstruction layer is cf². Further, a target codeword S may be obtained by compressing the first correlation feature vector by the compression neural network according to a preset compression rate η through the dimensionality reduction fully connected layer. The dimension of the target codeword S is cf²η.

In the above example, the feedback target codeword may be obtained by compressing the first correlation feature matrix on the terminal side, and CSI feedback is implemented based on the correlation among the feature information of a plurality of dimensions, such that the precision of compression feedback is improved.

In some examples, as shown with reference to FIG. 7, FIG. 7 is a flowchart of an information feedback method illustrated according to an example. The information feedback method may be used at the terminal, and may include the following steps 701-702.
in step 701, first signaling sent by the base station is received.

In the example of the disclosure, first network parameters corresponding to a plurality of neural network layers included in a target encoding neural network may be sent by the base station side to the terminal via the first signaling. The first signaling may be physical layer signaling, radio resource control (RRC) signaling, etc., which is not limited by the disclosure. The target encoding neural network includes the first multi-feature analysis network and the compression neural network for compressing the first correlation feature matrix.

In step 702, the target encoding neural network is obtained by configuring, based on the first network parameters, network parameters corresponding to a plurality of neural network layers included in an initial encoding neural network pre-deployed on the terminal.

In the example of the disclosure, the terminal side may pre-deploy the initial encoding neural network, which has a network architecture that is consistent with a network architecture of the target encoding neural network, but the initial encoding neural network has not yet been trained. The terminal may directly configure the network parameters corresponding to the plurality of neural network layers included in the initial encoding neural network based on the first network parameters included in the first signaling, and thus the target encoding neural network is obtained.

Subsequently, the first correlation feature matrix outputted from the first multi-feature analysis network and used for indicating the correlation among the plurality of pieces of feature information of the CSI may be obtained by inputting the first CSI matrix into the first multi-feature analysis network of the target encoding neural network through the terminal, and the first CSI matrix is a matrix used for indicating the different angle values corresponding to the different feedback paths when the terminal feeds the CSI by the antenna back to the base station. Further, the target codeword corresponding to the CSI is obtained by compressing the first CSI matrix by the terminal through the compression neural network in the target encoding neural network so as to feed the target codeword to the base station by the antenna.

In the above example, training may be performed at the base station side, and the target encoding neural network may be obtained by directly configuring the initial encoding neural network through the terminal according to the network parameters issued by the base station, with easy implementation and high usability.

In some examples, as shown with reference to FIG. 8, FIG. 8 is a flowchart of an information feedback method illustrated according to an example. The information feedback method may be used at the terminal, and may include the following steps 801-802.

In step 801, second signaling sent by the base station is received.

In the example of the disclosure, the second signaling includes updated first network parameters corresponding to the plurality of neural network layers included in the target encoding neural network, and the target encoding neural network includes the first multi-feature analysis network and the compression neural network used for compressing the first correlation feature matrix.

The base station side may send the updated first network parameters to the terminal via the second signaling when it is determined that the first network parameters corresponding to the plurality of neural network layers included in the first multi-feature analysis network are updated. The second signaling may be physical layer signaling or RRC signaling, which is not limited by the disclosure.

In step 802, an updated target encoding neural network is obtained by updating, based on the updated first network parameters, the network parameters corresponding to the plurality of neural network layers included in the target encoding neural network.

In the above example, the base station may send the updated first network parameters to the terminal, and the terminal may directly perform an update, with easy implementation and high usability.

The information feedback method provided by the disclosure is described again below from the base station side.

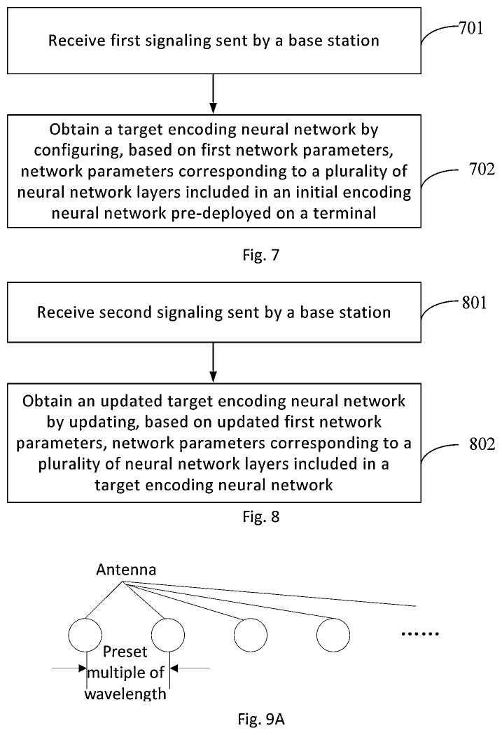

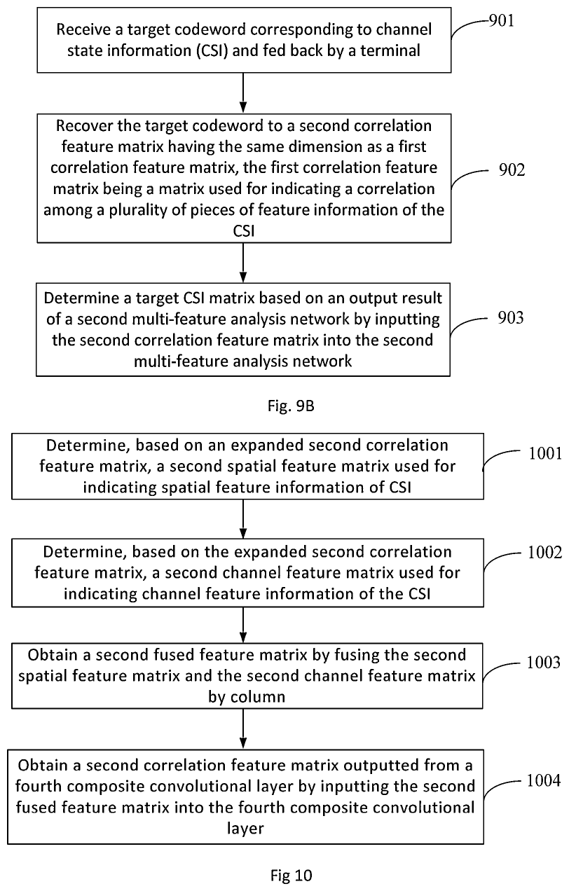

The example of the disclosure provides an information feedback method that may be used at the base station, on which a uniform linear array (ULA) manner may be used. Referring to FIG. 9A, f antennas are configured in accordance with a preset multiple of wavelength intervals, where the preset multiple may be ½, i.e., the f antennas are configured in accordance with half wavelength intervals, and f is a positive integer, which may be set as needed. A single antenna may be used on the terminal side, thus implementing MIMO-OFDM (orthogonal frequency division multiplexing) communication.

As shown with reference to FIG. 9B, which is a flowchart of an information feedback method illustrated according to an example, the method may include the following steps 901-903.

In step 901, a target codeword corresponding to channel state information (CSI) and fed back by a terminal is received.

The terminal side first determines a first CSI matrix, the first CSI matrix is a matrix used for indicating different angle values corresponding to different feedback paths when the terminal feeds the CSI by the antenna back to the base station, then a first correlation feature matrix outputted from a first multi-feature analysis network and used for indicating a correlation among a plurality of pieces of feature information of the CSI is obtained by inputting the first CSI matrix into the first multi-feature analysis network, and the target codeword is obtained after compressing the first correlation feature matrix.

In step 902, the target codeword is recovered to a second correlation feature matrix having the same dimension as the first correlation feature matrix, and the first correlation feature matrix is a matrix used for indicating the correlation among the plurality of pieces of feature information of the CSI.

In the example of the disclosure, the target codeword may first be recovered to the second correlation feature matrix, which has the same dimension as the first correlation feature matrix determined on the terminal side. The first correlation feature matrix is a matrix used to indicate the correlation among the plurality of pieces of feature information of the CSI.

In step 903, a target CSI matrix is determined based on an output result of a second multi-feature analysis network by inputting the second correlation feature matrix into the second multi-feature analysis network.

In the example of the disclosure, the target CSI matrix is a matrix, determined by the base station, of different angle values corresponding to different feedback paths when the terminal feeds the CSI by the antenna back to the base station. The target CSI matrix and the first CSI matrix determined on the terminal side need to be approximately equal.

The number of the second multi-feature analysis network may be one or more, and when the number of the second multi-feature analysis networks is more than one, the plurality of second multi-feature analysis networks are connected in a cascade manner.

In the above example, the base station may, based on the target codeword fed back by the terminal, first recover the target codeword to the second correlation feature matrix having the same dimension as the first correlation feature matrix, and then determine the target CSI matrix based on the second correlation feature matrix, which realizes the purpose of recasting the CSI matrix of different angle values corresponding to different feedback paths at the base station side when the terminal feeds the CSI by the antenna back to the base station, thus improving the accuracy of performing the recasting of the CSI matrix on the base station side.

In some examples, the base station may recover the target codeword to the second correlation feature matrix having the same dimension as the first correlation feature matrix through a recovery neural network.

Specifically, the recovery neural network may consist of a fully connected layer and a reconstruction layer. The fully connected layer is linear, i.e., the fully connected layer does not need to be composited with the activation function layer and the batch normalization layer. The input dimension of the fully connected layer is cf²η. The fully connected layer amplifies the target codeword based on a preset compression rate η, thus a second correlation feature vector is obtained, and a dimension of the second correlation feature vector is cf². Further, a dimension transformation is performed by the reconstruction layer, the dimension of the inputted second correlation feature vector is cf², and the dimension of the outputted second correlation feature matrix is c×f×f.

In the above example, the base station may first recover the target codeword to the second correlation feature matrix, which has the same dimension as the first correlation feature matrix, to facilitate subsequent recasting of the CSI matrix with high usability.

In some examples, the base station may expand the number of channels of the second correlation feature matrix by a channel expansion neural network to increase the quantity of learnable channel features for recasting the CSI matrix on the base station side, so that the performance of the subsequent second multi-feature analysis network is improved, and the first CSI matrix is recast with high precision on the base station side, i.e., the precision of the obtained target CSI matrix is improved.

In the example of the disclosure, the channel expansion neural network may consist of a composite convolutional layer. The composite convolutional layer is formed by at least compositing a convolutional layer with at least one other neural network layer. The size of convolutional kernels of the convolutional layer may be k×k, and the number of the convolutional kernels is F and is the same as the number of channels of the expanded second correlation feature matrix. The number of the channels of the second correlation feature matrix is expanded from c to F by a third composite convolutional layer, where F is a positive integer (generally an even number) greater than c, c may be 2 in the example of the disclosure, and F may be 64.

Further, a fourth CSI matrix outputted from the second multi-feature analysis network is obtained by inputting the expanded second correlation feature matrix into the second multi-feature analysis network by the base station. Since the number of channels of the fourth CSI matrix is greater than the number of channels of the first CSI matrix, the base station side may also obtain a target CSI matrix with the same number of channels as the first CSI channel by reducing the number of channels of the fourth CSI matrix.

In the above examples, the base station may expand the number of the channels of the second correlation feature matrix to increase the quantity of learnable channel features for recasting the CSI matrix on the base station side, which is high in usability.

In some examples, the plurality of pieces of feature information of the CSI at least include spatial feature information of the CSI and channel feature information of the CSI.

As shown with reference to FIG. 10, FIG. 10 is a flowchart of an information feedback method illustrated according to an example. The information feedback method may be used at the base station, on which the second multi-feature analysis network is deployed, and a process of determining the fourth CSI matrix by the second multi-feature analysis network may include the following steps 1001-1004.

In step 1001, based on the expanded second correlation feature matrix, a second spatial feature matrix used for indicating the spatial feature information of the CSI is determined.

In step 1002, based on the expanded second correlation feature matrix, a second channel feature matrix used for indicating the channel feature information of the CSI is determined.

In step 1003, a second fused feature matrix is obtained by fusing the second spatial feature matrix and the second channel feature matrix by column.

In step 1004, the second correlation feature matrix outputted from a fourth composite convolutional layer is obtained by inputting the second fused feature matrix into the fourth composite convolutional layer.

The fourth composite convolutional layer is obtained by compositing a fourth convolutional layer with at least one other neural network layer. A size of convolutional kernels of the fourth convolutional layer is 1×1, and the number of the convolutional kernels of the fourth convolutional layer is the same as the number F of channels inputted into the fourth composite convolutional layer. The number F of the channels is a positive integer greater than c. The at least one other neural network layer includes, but is not limited to, a batch normalization layer and an activation function layer.

In the above example, a fourth CSI matrix may be determined by the second multi-feature analysis network based on the expanded second correlation feature matrix, so that a target CSI matrix with a smaller difference from the first CSI is obtained through subsequent recasting, which improves the accuracy of recasting the CSI matrix on the base station side.

In some examples, the second spatial feature matrix outputted from a fourth number of fifth composite convolutional layers may be obtained by inputting the expanded second correlation feature matrix into the fourth number of the fifth composite convolutional layers, and each of the fifth composite convolutional layers is obtained by compositing the fifth convolutional layer with at least one other neural network layer, where at least two of the fifth convolutional layers have convolutional kernels of different sizes.

The structure of the fourth number of the fifth composite convolutional layers may be similar to the structure of the second number of the second composite convolutional layers shown in FIG. 5, the fourth number may be a positive integer greater than 2, assuming that the fourth number is 3, the sizes of the convolutional kernels of the three fifth convolutional layers may be i×i, 1×j, and j×1 respectively, and the number of convolutional kernels of each of the fifth convolutional layers is F, which is the same as the number of channels inputted into each of the fifth composite convolutional layers.

In the example of the disclosure, for better mining spatial features, i<j may be set, and i and j are both positive integers. In addition, more feature information is mined by alternating fifth convolutional layers with convolutional kernel of sizes 1×j and j×1 compared to the fifth convolutional layer with the convolutional kernel of the size j×j.

In the above example, a second spatial feature matrix may be obtained by extracting spatial features from the fourth number of the fifth composite convolutional layers, which is easy to implement and has high usability.

In some examples, the base station side determines the second channel feature matrix in a similar manner as the terminal side determines the first channel feature matrix, the network structure for determining the second channel feature matrix may be shown with reference to FIG. 6, and at this time, the network parameters involved may be different from the network parameters in FIG. 6.

A specific manner is as follows: the second spatial feature matrix outputted from the fourth number of fifth composite convolutional layers is obtained by inputting the expanded second correlation feature matrix into the fourth number of fifth composite convolutional layers, and each fifth composite convolutional layer is obtained by compositing the fifth convolutional layer with at least one other neural network layer. Sizes of convolutional kernels of at least two fifth convolutional layers are different, and the number of the convolutional kernels of each fifth convolutional layer is the same as the number of channels inputted into each fifth composite convolutional layer.

The dimension of the CSI matrix inputted into the average pooling layer or the maximum pooling layer is F×f×f, where F is the number of channels of the expanded second channel feature matrix. The dimension of the first fully connected layer may be

$$F \times \frac{F}{R} ,$$

and the dimension of the last fully connected layer is L×F, where

$$R < F , \frac{F}{R}$$

is a positive integer, L is the input dimension of the last fully connected layer, and R and L are positive integers, which may be set as needed.

Further, a fourth feature matrix used for indicating average global channel feature information of the CSI, and a fifth feature matrix used for indicating maximum global channel feature information of the CSI may be determined by the base station based on the expanded second correlation feature matrix. Specifically, the fourth feature matrix outputted by the third composite layer may be obtained by inputting the expanded second correlation feature matrix into the third composite layer by the base station, and the third composite layer is obtained by at least compositing the average pooling layer with a fifth number of third fully connected layers. The fifth feature matrix outputted from the fourth composite layer may be obtained by inputting the expanded second correlation feature matrix into the fourth composite layer by the base station, and the fourth composite layer is obtained by at least compositing the maximum pooling layer with the fifth number of fourth fully connected layers.

In the example of the disclosure, network parameters corresponding to the fifth number of third fully connected layers are the same as network parameters corresponding to the fifth number of fourth fully connected layers.

In some examples, the target CSI matrix may be obtained by reducing the number of channels of the fourth CSI matrix by the base station through a recast neural network on the base station side.

Specifically, the recast neural network may consist of a sixth composite convolutional layer and a nonlinear activation function layer. The target CSI matrix is obtained by reducing the number of channels of the fourth CSI matrix outputted from the second multi-feature analysis network to a sixth number, where the sixth composite convolutional layer is obtained by compositing a sixth convolutional layer with at least one other neural network layer, the at least one other neural network layer includes but is not limited to a batch normalization layer and an activation function layer, and the sixth number is the same as the number of channels corresponding to the first CSI matrix.

The size of convolutional kernels of the sixth convolutional layer is 1×1, and the number of the convolutional kernels of the sixth convolutional layer is the same as the sixth number. Thus the number of channels of the fourth CSI matrix is reduced to the sixth number.

In the above example, the target CSI matrix may be obtained by the base station side by recasting the fourth CSI matrix, improving the accuracy of recasting of the CSI matrix performed on the base station side.

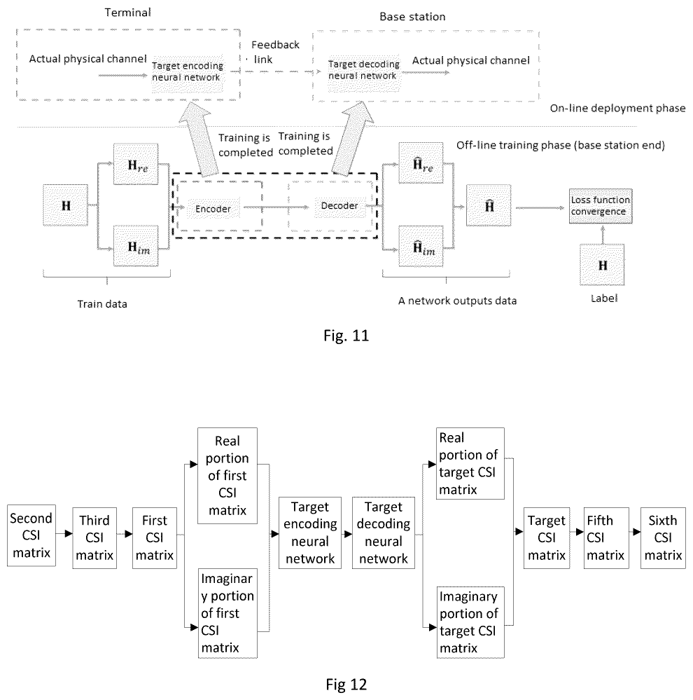

In some examples, the network consisting of the initial encoding neural network and the initial decoding neural network may be trained on the base station side, after the training is completed, the target encoding neural network and the target decoding neural network are obtained, and a schematic diagram of a training interaction is shown with reference to FIG. 11.

The initial encoding neural network is an untrained neural network having the same network structure as the target encoding neural network, and the initial decoding neural network is an untrained neural network having the same network structure as the target decoding neural network.

The target encoding neural network includes a first multi-feature analysis network used for determining the first CSI matrix and a compression neural network used for compressing the first correlation feature matrix; and the target decoding neural network at least includes the second multi-feature analysis network and a recovery neural network used for recovering the target codeword to the second correlation feature matrix. In the example of the disclosure, the target decoding neural network may further include the channel expansion neural network and the recast neural network above.

Since the initial encoding neural network has been deployed on the terminal side, the base station sends first network parameters corresponding to the plurality of neural network layers included in the target encoding neural network to the terminal via the first signaling, and the terminal may obtain the target encoding neural network by configuring the initial encoding neural network based on the first network parameters. The base station side is pre-deployed with the initial decoding neural network, and the target decoding neural network may be obtained by configuring the network parameters corresponding to the plurality of neural network layers included in the initial decoding neural network pre-deployed on the base station according to the second network parameters obtained by training corresponding to the plurality of neural network layers included in the target decoding neural network.

In the example of the disclosure, the base station side may complete training of the network consisting of the initial encoding neural network and the initial decoding neural network in the following manner:
a plurality of first sample CSI matrices are first obtained. The first sample CSI matrices are matrices used to indicate different sample parameter values corresponding to different space domains and frequency domains when the terminal feeds the CSI by the antenna back to the base station.

Further, a plurality of second sample CSI matrices may be obtained by performing a two-dimensional discrete Fourier transform on the plurality of the first sample CSI matrices through the base station.

Further, a plurality of third sample CSI matrices H=[Hᵣₑ; Hᵢₘ] ∈ [symbol] ^{2×f×f} may be obtained by retaining a first number of non-zero rows of parameter values in an order from front to back in the plurality of second sample CSI matrices through the base station, and the first number is the same as the total number of antennas deployed at the base station.

Further, a plurality of alternative CSI matrices may be determined by inputting the plurality of third sample CSI matrices into the initial encoding neural network through the base station based on an output result of the initial decoding neural network, and the initial encoding neural network is connected to the initial decoding neural network through an analog channel.

The base station uses the plurality of third sample CSI matrices as supervision and adopts an end-to-end supervised learning training manner to train the initial encoding neural network and the initial decoding neural network, and determines that the training is completed when a difference between the plurality of alternative CSI matrices and the plurality of third sample CSI matrices is at the minimum, so that the first network parameters corresponding to the plurality of neural network layers included in the target encoding neural network and the second network parameters corresponding to the plurality of neural network layers included in the target decoding neural network are obtained.

In the above example, the initial encoding neural network and the initial decoding neural network may be trained on the base station side, and the subsequent configuration may be performed directly according to the network parameters obtained from the training on the terminal side and the base station side respectively, which is easy to implement and has high usability.

In some examples, if the sample CSI matrices of the base station side are updated, then the base station side may retrain the initial encoding neural network and the initial decoding neural network in the manner above, and thus updated first network parameters and updated second network parameters are obtained.

The base station may send the updated first network parameters to the terminal via the second signaling so that the terminal updates the network parameters corresponding to the plurality of neural network layers included in the target encoding neural network based on the updated first network parameters, and thus an updated target encoding neural network is obtained.

In addition, an updated target decoding neural network may be obtained by updating, based on the updated second network parameters, the network parameters corresponding to the plurality of neural network layers included in the target decoding neural network by the base station.

In the above example, the target encoding neural network and the target decoding neural network may be quickly updated on the terminal side and the base station side, which has high usability.

In some examples, parameter values corresponding to the target CSI matrix may be added to the fifth CSI matrix in an order from front to back, additionally other parameter values in the fifth CSI matrix may be zero, and the finally determined dimensions of the fifth CSI matrix are the same as the dimensions of the third CSI matrix on the terminal side.

Further, a sixth CSI matrix may be obtained by performing a two-dimensional inverse discrete Fourier transform on the fifth CSI matrix, and the sixth CSI matrix is a matrix determined on the base station side and used for indicating different parameter values corresponding to different space domains and frequency domains when the terminal feeds the CSI by the antenna back to the base station. The sixth CSI matrix is a matrix approximately the same as the second CSI matrix obtained by recasting on the base station side.

In the above example, the base station may obtain the sixth CSI matrix through recasting, so that different parameter values corresponding to different space domains and frequency domains when the terminal feeds the CSI by the antenna back to the base station are determined, which has high usability.

Further examples of the information feedback methods provided by the disclosure are described below.

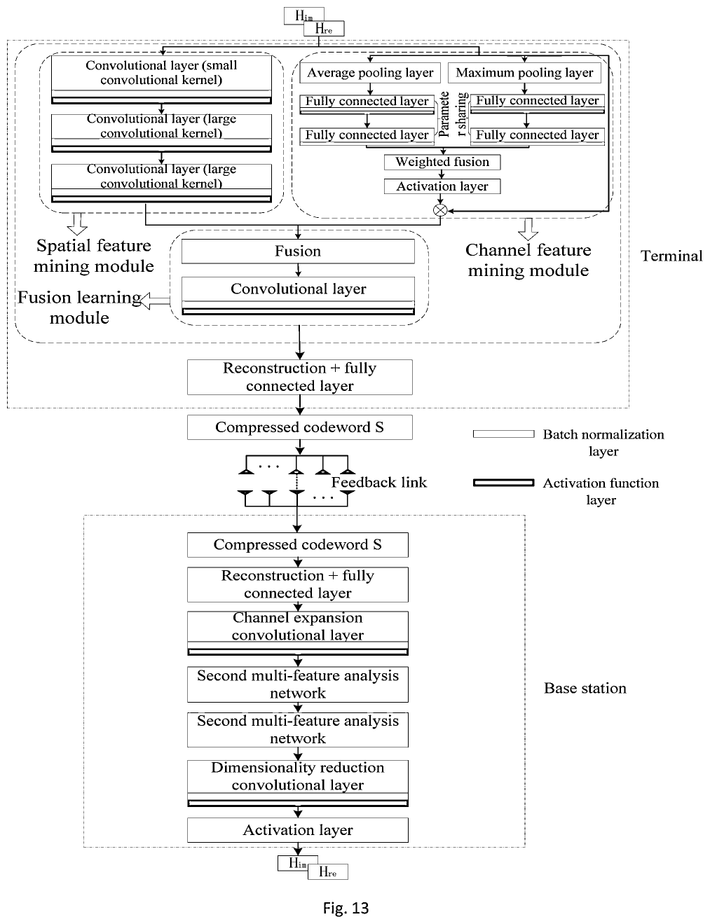

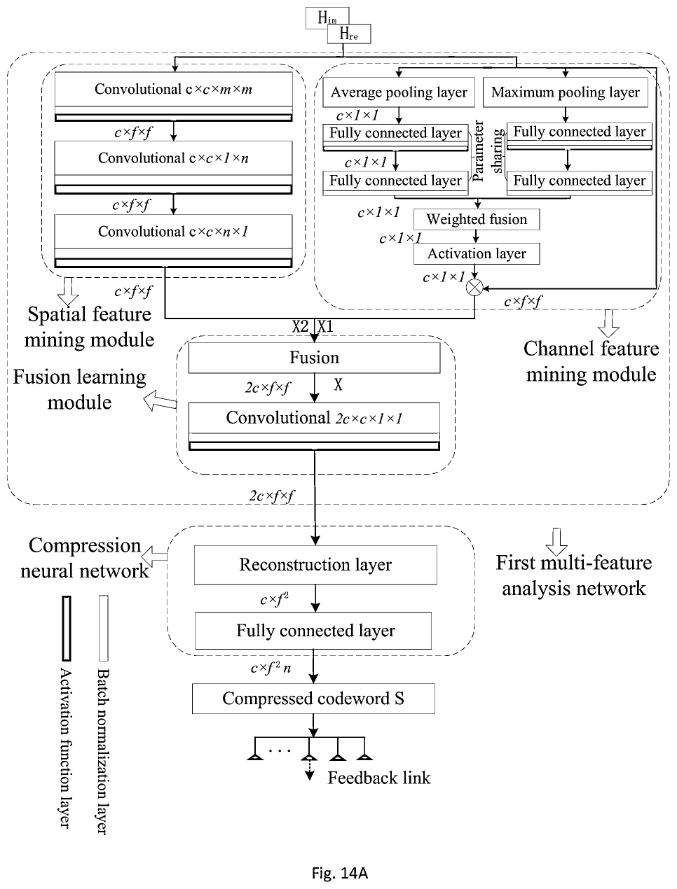

An overall processing process is shown with reference to FIG. 12, where structures of the target encoding neural network and the target decoding neural network provided by the disclosure are shown with reference to FIG. 13.

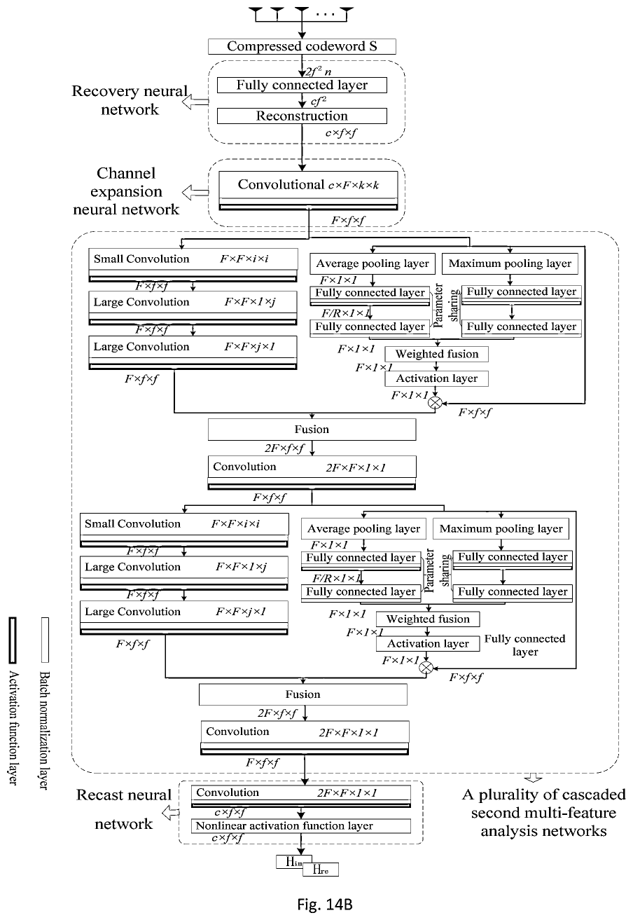

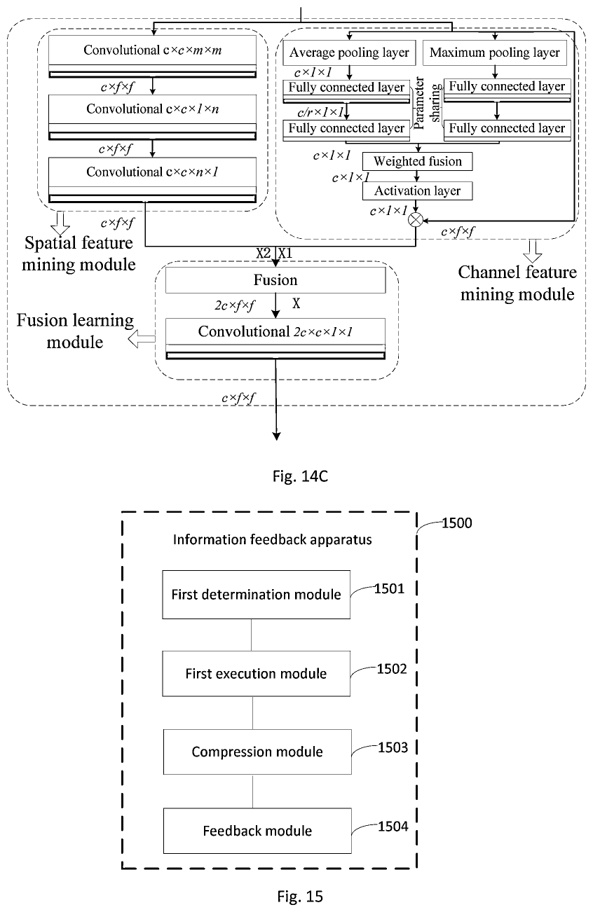

The specific network structure of the target encoding neural network may be shown with reference to FIG. 14A, and the specific network structure of the target decoding neural network may be shown with reference to FIG. 14B, where the network structure of the first multi-feature analysis network or the second multi-feature analysis network may be shown with reference to FIG. 14C.

The information feedback method includes the following steps 1-7.

Step 1, the terminal determines a first channel state information (CSI) matrix.

In a downlink of a MIMO-OFDM system, f=32 antennas are configured on the base station side in a ULA manner at half-wavelength intervals, a single antenna is configured on the terminal side, N_{c}=1024 subcarriers are adopted, and 150,000 first sample CSI matrices Ĥ′ are generated in a 5.3 GHz indoor pico-cellular scenario by using a COST2100[7] channel model.

The 150,000 first sample CSI matrices may be divided into a training set containing 100,000 samples, a validation set containing 30,000 samples, and a test set containing 20,000 samples.

After training the initial encoding neural network and the initial decoding neural network based on the plurality of samples in the training set for a period of time, the CSI matrix in the validation set may be used for validating the encoding neural network and the decoding neural network that have been trained for that period of time, and then execution returns to continue the process of training the initial encoding neural network and the initial decoding neural network based on the plurality of samples in the training set. The test set is used for actual testing of the target encoding neural network and the target decoding neural network after the training is completed, i.e., the actual application process.

The test set in the first sample CSI matrix is used as the second CSI matrix H for the actual CSI feedback. The third CSI matrix Ha is obtained by performing a two-dimensional DFT on Ĥ based on the formula 1 above, where the size of Ĥ′ is 1024×32, Fₐ and F_{b} are DFT matrices of sizes 1024×1024 and 32×32 respectively, and the superscript H denotes the conjugate transpose of the matrix. Since Ha contains just the first 32 non-zero rows, non-zero principal value retention is performed on Ha to retain the first number of non-zero rows, and the first CSI matrix obtained after non-zero principal value retention is denoted as H with a size 32×32. The real and imaginary portions of H are taken out and denoted as Hᵣₑ and Hᵢₘ respectively, with sizes 1×32×32 and [Hᵣₑ; Hᵢₘ]∈ [symbol] ^{2×f×f} and the number of data channels is c=2.

Step 2, a first correlation feature matrix outputted from a first multi-feature analysis network and used for indicating a correlation among a plurality of pieces of feature information of the CSI is obtained by inputting the first CSI matrix into the first multi-feature analysis network.

The first multi-feature analysis network of the target encoding neural network consists of three parts: a spatial feature mining module, a channel feature mining module, and a fusion learning module, the compression neural network of the target encoding neural network includes a reconstruction layer and a fully connected layer, which are both deployed on the terminal side, and its detailed structure is shown in FIG. 5.

First, the first multi-feature analysis network utilizes the spatial feature mining module to deeply mine the spatial dimension features of the CSI matrix. The module consists of three second composite convolutional layers (including a convolutional layer, a batch normalization layer and an activation function layer), the input values are the real and imaginary portions of the first CSI matrix with the dimension 2×32×32, the first second convolutional layer has the convolutional kernel size 3×3, the number of convolutional kernels is 2, and the remaining second convolutional layer adopts convolutional kernel sizes 1×9 and 9×1, and the number of convolutional kernels is 2. The normalization layer is the batch normalization layer, and the activation function is LeakyReLU function. The LeakyReLU function may be represented through a following formula 3:

$$LeakyReLU ( x ) = \{ \begin{matrix}x , & x \geq 0 \\ 0.3 x , & x < 0\end{matrix} \qquad formula 3$$

The convolutional layer above may be zero-padded to make the input dimension and the output dimension the same.

Secondly, the first multi-feature analysis network utilizes the channel feature mining module to mine the channel dimension features of the CSI matrix. It is divided into two parts: the first part consists of an average pooling layer and two fully connected layers, the dimension of the inputted CSI matrix is 2×32×32, r=2 and l=1 are set, the dimension of the first fully connected layer is 2×1, the activation function adopts the LeakyReLU function, the dimension of the second fully connected layer is 1×2, and the activation function adopts a Sigmoid function, which may be represented in the following formula 4:

$$Sigmoid ( x ) = \frac{1}{1 + {e}^{- x}} \qquad formula 4$$

The second part consists of a maximum pooling layer and two fully connected layers, and the second part and the first part are consistent in setup and share network parameters.

The first multi-feature analysis network uses adaptive weighted fusion in the channel feature mining module to perform a weighted fusion on mined average global information features and maximum global information features, and the fusion formula is the formula 2 above, where W1 and W2 are set to be initialized as 1 and 1 respectively.

The fusion learning module of the first multi-feature analysis network may perform fusion learning and mining on outputs of the spatial feature mining module and the channel feature mining module. First, the spatial dimension features are spliced with the channel dimension features by column. The spliced and fused dimension is 4×32×32. The first correlation feature matrix outputted by the first composite convolutional layer is obtained after the spliced and fused first fused feature matrix passes through the first composite convolutional later. The first composite convolutional layer is obtained by compositing a first convolutional layer with at least one other neural network layer. A size of convolutional kernels of the first convolutional layer is 1×1, and the number of the convolutional kernels is 2.

Step 3, a target codeword corresponding to the CSI is obtained by compressing the first correlation feature matrix through the terminal.

The outputted first correlation feature matrix is inputted into a compression neural network for compression. The compression neural network includes 1 reconstruction layer and 1 dimensionality reduction fully connected layer. The reconstruction layer plays the role of dimension transformation, transforming the output dimension of the first correlation feature matrix from 2×32×32 to 2048, after which it is input into the linear fully connected layer for compression with an input dimension being 2048 and an output dimension being 2048η, where η is the compression rate, which is generally a positive number greater than 0 and less than 1.

Step 4, the terminal feeds the target codeword back to the base station by the antenna.

Step 5, the base station recovers the target codeword to the second correlation feature matrix having the same dimension as the first correlation feature matrix.

The target decoding neural network includes a recovery neural network, a channel expansion neural network, a plurality of second multi-feature analysis networks, and a recast neural network, which are deployed on the base station side. The base station first recovers the received target codeword by the recovery neural network, and recovers the target codeword to the second correlation feature matrix with the same dimension as the first correlation feature matrix. The recovery neural network consists of 1 fully connected layer and 1 reconstruction layer. The fully connected layer is linear, with no activation function and batch normalization, and the input and output dimensions are 2048η and 2048 respectively. The reconstruction layer is used for dimensional transformation with the input dimension being 2048 and the output dimension being 2×32×32.

Step 6, an expanded second correlation feature matrix is obtained by expanding the number of channels of the second correlation feature matrix by the base station.

The base station increases and expands the number of channels of the second correlation feature matrix by the channel expansion neural network. The channel expansion neural network consists of 1 third composite convolutional layer, the third composite convolutional layer is obtained by at least compositing the third convolutional layer with at least one other neural network layer, the size of the convolutional kernels of the third convolutional layer is 5×5, the number of convolutional kernels of the third convolutional layer is F=64, and the second correlation feature matrix is expanded from 2 channels to F channels.

Step 7, a target CSI matrix is determined based on output results of second multi-feature analysis networks by inputting the second correlation feature matrix into the second multi-feature analysis networks through the base station.

The number of the second multi-feature analysis networks is 2 for extracting the feature information of the expanded second correlation feature matrix so as to efficiently recover the target CSI matrix.

The spatial feature mining module in each second multi-feature analysis network consists of three fifth composite convolutional layers (combined layers of convolutional, normalization, and activation function layers), the inputted extended second correlation feature matrix has the dimension 64×32×32, the first fifth convolutional layer has the convolutional kernels of a size 3×3 and a number 64, and the other fifth convolutional layers use alternating convolutional layers with convolutional kernels of sizes 1×9 and 9×1 and a number 64. The channel feature mining module is divided into two parts: the first part consists of an average pooling layer and two fully connected layers, the dimension of the expanded second correlation feature matrix is 64×32×32, R=8 and L=8 are set, the dimension of the first fully connected layer is 64×8, and the dimension of the last fully connected layer is 8×64.

After the 2 cascaded second multi-feature analysis networks output the fourth CSI matrix, the base station may obtain the target CSI matrix through the recast neural network. The recast neural network consists of a dimensionality reduction convolutional layer and a nonlinear activation function layer. The dimensionality reduction convolutional layer consists of a sixth composite convolutional layer with the convolutional kernel size 1×1, the number 1×1 of convolutional kernels, the input dimension 64×32×32, and the output dimension 2×32×32. The nonlinear activation function layer uses a Sigmoid activation function to nonlinearly activate the output of the dimensionality reduction convolutional layer to improve the learning performance of the network.

In the above process, the first multi-feature analysis network and the second multi-feature analysis network use the spatial mining module to learn features on the spatial dimension of the CSI matrix, and use the channel mining module to selectively enhance useful features on the channel dimension and suppress useless features respectively. An adaptive weighted fusion manner is used for fusing the maximum channel features and the average channel features. This fusion manner, which fully takes into account the magnitude of the amount of information of the channel dimension features, drastically improves the learning performance of the network and makes the channel recasting more efficient and effective. The fusion learning module is additionally designed to perform fusion learning and mining on the outputs of the spatial feature mining module and the channel feature mining module. The spatial dimension features and the channel dimension features are spliced by column, after which the correlation between different dimension features is learned to strengthen the correlation of features between different dimensions and improve the learning performance, thus improving the representation capability of the network. Unified learning of features of different dimensions through the layer makes a difference between CSI matrix features more clear, elements that play a dominant role are strengthened, and redundant elements are weakened, so that a compressed channel is conductive to recasting. The channel expansion neural network is designed on the base station side to expand the CSI matrix to improve the amount of learnable channel features for recasting the CSI matrix, which further improves the performance of a subsequent two-feature network to recover features and recast the CSI matrix with high precision.

In some examples, the initial encoding neural network and the initial decoding neural network may be trained on the base station side. The training data may be the data in the training set above, and denoted as Ĥ′=[Hᵣₑ; Hᵢₘ]∈ [symbol] ^{2×32×32}. An end-to-end supervised learning training manner is used. Alternatively, an Adam optimization algorithm may be used with an epoch of T=1500, and when a complete data set passes through the neural network once and returns once, the process is referred to as an epoch. A learning rate is determined in a warm-up manner, and a determining manner refers to a formula 5:

$$η = {η}_{min} + \frac{1}{2} ( {η}_{max} - {η}_{min} ) ( 1 + cos ( \frac{t - {T}_{w}}{T - {T}_{w}} π ) ) \qquad formula 5$$

where variables are initialized to ηₘᵢₙ=5e⁻⁵ and ηₘₐₓ=2e⁻³, and the number of warm-up is T_{w}=30. The goal is to minimize the difference between the outputs Ĥ′=[Ĥᵣₑ; Hᵢₘ] and Ĥ′=[Hᵣₑ; Hᵢₘ] of a CSI feature decompression decoder with the loss function shown in a formula 6:

$$Loss = \frac{1}{s} {\sum }_{i = 1}^{s} ‖ \hat{H} [ i ] - H [ i ] ‖ \qquad formula 6$$

where S is a training set sample, ∥·∥ is a Euclidean norm, and [i] denotes an i^{th} sample. Model parameters mainly include weights and biases of the fully connected layer, the weights and the biases of the convolution kernel and the weights and the biases of an inverse convolution kernel.

An entire training flowchart is a training process shown in FIG. 11 above. After training, the model parameters are saved.

For the deployment phase, the initial encoding neural network is pre-deployed on the terminal side, and the initial decoding neural network is deployed on the base station side. Configuration is performed by using trained model parameters, i.e., first network parameters corresponding to the plurality of neural network layers included in the target encoding neural network and second network parameters corresponding to the plurality of neural network layers included in the target decoding neural network.

The above first network parameters may be sent to the terminal via the first signaling so that the terminal configures the initial encoding neural network based on the first network parameters, and thus the target encoding neural network is obtained.

The base station side configures the initial decoding neural network based on the second network parameters, and thus the target decoding neural network is obtained.

If the base station side determines that the first network parameters are updated, the updated first network parameters may be sent to the terminal via the second signaling, so that the terminal may update the target encoding neural network.

In addition, if the base station side determines that the second network parameters are updated, based on updated second network parameters, an updated target decoding neural network may be obtained by updating network parameters corresponding to the plurality of neural network layers included in the target decoding neural network on the base station.

In the above example, training may be performed on the base station side, and the network parameters obtained from the training may be subsequently informed to the terminal, so that even if the network parameters are updated, the update may be quickly synchronized on the terminal and the base station side, and the usability is high.

Corresponding to the foregoing examples of application function realization methods, the disclosure also provides examples of application function realization apparatuses.

Referring to FIG. 15, FIG. 15 is a block diagram of an information feedback apparatus illustrated according to an example. The information feedback apparatus 1500 is used for a terminal and includes:
a first determination module 1501, configured to determine a first channel state information (CSI) matrix, the first CSI matrix being a matrix used for indicating different angle values corresponding to different feedback paths when the terminal feeds CSI by an antenna back to a base station;
a first execution module 1502, configured to obtain a first correlation feature matrix outputted from a first multi-feature analysis network and used for indicating a correlation among a plurality of pieces of feature information of the CSI by inputting the first CSI matrix into the first multi-feature analysis network;
a compression module 1503, configured to obtain a target codeword corresponding to the CSI by compressing the first correlation feature matrix; and
a feedback module 1504, configured to feed the target codeword back to the base station by the antenna.

The specific implementation is similar to the implementation of the example shown in FIG. 2 and will not be repeated here.

In some examples, the first determination module includes:
a first determination submodule, configured to determine a second CSI matrix, the second CSI matrix being a matrix used for indicating different parameter values corresponding to different space domains and frequency domains when the terminal feeds the CSI by the antenna back to the base station;
a second determination submodule, configured to obtain a third CSI matrix by performing a two-dimensional discrete Fourier transform on the second CSI matrix; and
a third determination submodule, configured to obtain the first CSI matrix by retaining a first number of non-zero rows of parameter values in an order from front to back in the third CSI matrix, the first number being the same as a total number of antennas deployed on the base station.

The specific implementation is similar to the implementation of the example shown in FIG. 3 and will not be repeated here.

In some examples, the plurality of pieces of feature information of the CSI at least include spatial feature information of the CSI and channel feature information of the CSI.

The information feedback apparatus 1500 further includes:
a second determination module, configured to determine, based on the first CSI matrix, a first spatial feature matrix used for indicating the spatial feature information of the CSI;
a third determination module, configured to determine, based on the first CSI matrix, a first channel feature matrix used for indicating the channel feature information of the CSI;
a fourth determination module, configured to obtain a first fused feature matrix by fusing the first spatial feature matrix and the first channel feature matrix by column; and
a fifth determination module, configured to obtain the first correlation feature matrix outputted from a first composite convolutional layer by inputting the first fused feature matrix into the first composite convolutional layer, the first composite convolutional layer being obtained by compositing a first convolutional layer with at least one other neural network layer.

Alternatively, a size of convolutional kernels of the first convolutional layer is 1×1, and the number of the convolutional kernels of the first convolutional layer is the same as the number of channels inputted into the first composite convolutional layer.

The specific implementation is similar to the implementation of the example shown in FIG. 4 and will not be repeated here.

In some examples, the second determination module includes:
a fourth determination submodule, configured to obtain the first spatial feature matrix outputted from a second number of second composite convolutional layers by inputting a real portion and an imaginary portion of the first CSI matrix into the second number of the second composite convolutional layers, each second composite convolutional layer being obtained by compositing a second convolutional layer with at least one other neural network layer.

Alternatively, sizes of convolutional kernels of at least two second convolutional layers are different, and the number of the convolutional kernels of each second convolutional layer is the same as the number of channels inputted into each second composite convolutional layer.

The specific implementation is similar to the implementation provided by a relevant example of FIG. 5 and will not be repeated here.

In some examples, the third determination module includes:
a fifth determination submodule, configured to determine, based on the first CSI matrix, a first feature matrix used for indicating average global channel feature information of the CSI, and a second feature matrix used for indicating maximum global channel feature information of the CSI;
a sixth determination submodule, configured to determine a fused third feature matrix by performing a weighted fusion on the first feature matrix and the second feature matrix; and
a seventh determination submodule, configured to determine, based on the third feature matrix and the first CSI matrix, the first channel feature matrix.

Alternatively, the fifth determination submodule is further configured to:
obtain the first feature matrix outputted from a first composite layer by inputting the real portion and the imaginary portion of the first CSI matrix into the first composite layer, the first composite layer being obtained by at least compositing an average pooling layer with a third number of first fully connected layers; and
obtain the second feature matrix outputted from a second composite layer by inputting the real portion and the imaginary portion of the first CSI matrix into the second composite layer, the second composite layer being obtained by at least compositing a maximum pooling layer with a third number of second fully connected layers.

Alternatively, network parameters corresponding to the third number of first fully connected layers are the same as network parameters corresponding to the third number of second fully connected layers.

The specific implementation is similar to the implementation provided by a relevant example of FIG. 6 and will not be repeated here.

In some examples, the compression module includes:
a dimensionality reduction submodule, configured to obtain a first correlation feature vector by performing a dimensionality reduction on the first correlation feature matrix; and
a compression submodule, configured to obtain the target codeword by compressing the first correlation feature vector according to a preset compression rate.

The specific implementation is similar to a processing process of the example provided on a terminal method side for obtaining the target codeword by compressing the first correlation feature matrix, and will not be repeated here.

In some examples, the information feedback apparatus 1500 further includes:
a second reception module, configured to receive first signaling sent by the base station; where the first signaling includes first network parameters corresponding to a plurality of neural network layers included in a target encoding neural network, and the target encoding neural network includes the first multi-feature analysis network and a compression neural network used for compressing the first correlation feature matrix; and
a first configuration module, configured to obtain the target encoding neural network by configuring, based on the first network parameters, network parameters corresponding to a plurality of neural network layers included in an initial encoding neural network pre-deployed on the terminal; where the initial encoding neural network is an untrained neural network having the same network structure as the target encoding neural network.

The specific implementation is similar to the implementation of the example shown in FIG. 7 and will not be repeated here.

In some examples, the information feedback apparatus 1500 further includes:
a third reception module, configured to receive second signaling sent by the base station; where the second signaling includes updated first network parameters corresponding to the plurality of neural network layers included in the target encoding neural network, and the target encoding neural network includes the first multi-feature analysis network and the compression neural network used for compressing the first correlation feature matrix; and
an update module, configured to obtain an updated target encoding neural network by updating, based on the updated first network parameters, the network parameters corresponding to the plurality of neural network layers included in the target encoding neural network.

The specific implementation is similar to the implementation of the example shown in FIG. 8 and will not be repeated here.

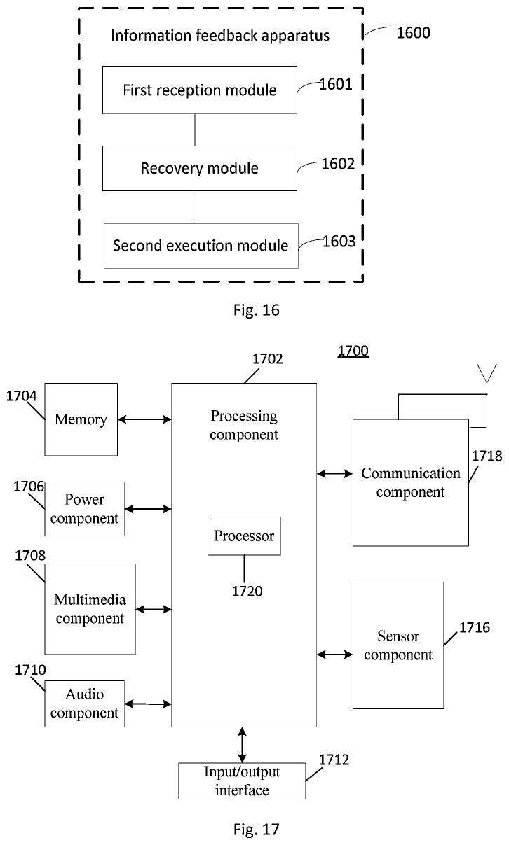

Referring to FIG. 16, FIG. 16 is a block diagram of an information feedback apparatus illustrated according to an example. The information feedback apparatus 1600 is used for a base station and includes:
a first reception module 1601, configured to receive a target codeword corresponding to channel state information (CSI) and fed back by a terminal;
a recovery module 1602, configured to recover the target codeword to a second correlation feature matrix having the same dimension as a first correlation feature matrix, the first correlation feature matrix being a matrix used for indicating a correlation among a plurality of pieces of feature information of the CSI; and
a second execution module 1603, configured to determine, based on an output result of a second multi-feature analysis network, a target CSI matrix by inputting the second correlation feature matrix into the second multi-feature analysis network;
where the target CSI matrix is a matrix, determined by the base station, of different angle values corresponding to different feedback paths when the terminal feeds the CSI by an antenna back to the base station.

The specific implementation is similar to the implementation of the example shown in FIG. 9B and will not be repeated here.

In some examples, the recovery module includes:
an amplifying module, configured to obtain a second correlation feature vector by amplifying the target codeword based on a preset compression rate; and
a dimensionality increase module, configured to obtain the second correlation feature matrix by performing a dimensionality increase on the second correlation feature vector.

The specific implementation is similar to the implementation provided in the example provided on the base station side of recovering the target codeword to a second correlation feature matrix having the same dimension as the first correlation feature matrix through a recovery neural network, and will not be repeated here.

In some examples, the information feedback apparatus 1600 further includes:
a channel expansion module, configured to obtain an expanded second correlation feature matrix by expanding the number of channels of the second correlation feature matrix.

The second execution module includes:
an eighth determination submodule, configured to obtain a fourth CSI matrix outputted from the second multi-feature analysis network by inputting the expanded second correlation feature matrix into the second multi-feature analysis network; and
a ninth determination submodule, configured to obtain the target CSI matrix by reducing the number of channels of the fourth CSI matrix.

Alternatively, the channel expansion module includes:
a tenth determination submodule, configured to obtain the expanded second correlation feature matrix outputted from a third composite convolutional layer by inputting the second correlation feature matrix into the third composite convolutional layer, the third composite convolutional layer being obtained by at least compositing a third convolutional layer with at least one other neural network layer.

Alternatively, the number of convolutional kernels of the third convolutional layer is the same as the number of channels of the expanded second correlation feature matrix.

The specific implementation is similar to a manner in which the base station expands the number of channels of the second correlation feature matrix by a channel expansion neural network, and will not be repeated.

In some examples, the plurality of pieces of feature information of the CSI at least include spatial feature information of the CSI and channel feature information of the CSI.

The information feedback apparatus 1600 further includes:
a first determination module, configured to determine, based on the expanded second correlation feature matrix, a second spatial feature matrix used for indicating the spatial feature information of the CSI;
a second determination module, configured to determine, based on the expanded second correlation feature matrix, a second channel feature matrix used for indicating the channel feature information of the CSI;
a third determination module, configured to obtain a second fused feature matrix by fusing the second spatial feature matrix and the second channel feature matrix by column; and
a fourth determination module, configured to obtain the second correlation feature matrix outputted from a fourth composite convolutional layer by inputting the second fused feature matrix into the fourth composite convolutional layer, the fourth composite convolutional layer being obtained by compositing a fourth convolutional layer with at least one other neural network layer.

Alternatively, a size of a convolutional kernel of the fourth convolutional layer is 1×1, and the number of the convolutional kernels of the fourth convolutional layer is the same as the number of channels inputted into the fourth composite convolutional layer.

The specific implementation is similar to the implementation of the example shown in FIG. 10 and will not be repeated here.

In some examples, the first determination module is further configured to:
obtain the second spatial feature matrix outputted from a fourth number of fifth composite convolutional layers by inputting the expanded second correlation feature matrix into the fourth number of fifth composite convolutional layers, the fifth composite convolutional layer being obtained by compositing a fifth convolutional layer with at least one other neural network layer.

In some examples, sizes of convolutional kernels of at least two fifth convolutional layers are different, and the number of the convolutional kernels of each fifth convolutional layer is the same as the number of channels inputted into each fifth composite convolutional layer.

In some examples, the second determination module includes:
an eleventh determination submodule, configured to determine, based on the expanded second correlation feature matrix, a fourth feature matrix used for indicating average global channel feature information of the CSI, and a fifth feature matrix used for indicating maximum global channel feature information of the CSI;
a twelfth determination submodule, configured to determine a fused sixth feature matrix by performing a weighted fusion on the fourth feature matrix and the fifth feature matrix; and
a thirteenth determination submodule, configured to determine, based on the sixth feature matrix and the second correlation feature matrix, the second channel feature matrix.

Alternatively, the eleventh determination submodule is further configured to:
obtain the fourth feature matrix outputted from a third composite layer by inputting the expanded second correlation feature matrix into the third composite layer, the third composite layer being obtained by at least compositing an average pooling layer with a fifth number of third fully connected layers; and
obtain the fifth feature matrix outputted from a fourth composite layer by inputting the expanded second correlation feature matrix into the fourth composite layer, the fourth composite layer being obtained by at least compositing a maximum pooling layer with a fifth number of fourth fully connected layers.

Alternatively, network parameters corresponding to the fifth number of third fully connected layers are the same as network parameters corresponding to the fifth number of fourth fully connected layers.

The specific implementation is similar to the implementation of determining the second channel feature matrix on the base station side and will not be repeated here.

In some examples, the ninth determination submodule is further configured to:
obtain the target CSI matrix by reducing the number of channels of the fourth CSI matrix to a sixth number by a sixth composite convolutional layer and a nonlinear activation function layer; where the sixth composite convolutional layer is obtained by compositing a sixth convolutional layer with at least one other neural network layer, and the sixth number is the same as the number of channels corresponding to the first CSI matrix.

Alternatively, a size of a convolutional kernel of the sixth convolutional layer is 1×1, and the number of the convolutional kernels of the sixth convolutional layer is the same as the sixth number.

The specific implementation is similar to the implementation of obtaining the target CSI matrix by the recast neural network on the base station side, and will not be repeated here.

In some examples, the information feedback apparatus 1600 further includes:
an obtaining module, configured to obtain a plurality of first sample CSI matrices, the first sample CSI matrices being matrices used for indicating different sample parameter values corresponding to different space domains and frequency domains when the terminal feeds the CSI by the antenna back to the base station;
a Fourier transform module, configured to obtain a plurality of second sample CSI matrices by performing a two-dimensional discrete Fourier transform on the plurality of the first sample CSI matrices;
a fifth determination module, configured to obtain a plurality of third sample CSI matrices by retaining a first number of non-zero rows of parameter values in an order from front to back in the plurality of second sample CSI matrices, the first number being the same as a total number of antennas deployed at the base station;
a sixth determination module, configured to determine, based on an output result of an initial decoding neural network, a plurality of alternative CSI matrices by inputting the plurality of third sample CSI matrices into an initial encoding neural network, the initial encoding neural network being connected to the initial decoding neural network through an analog channel; and
a training module, configured to determine, at a minimum difference between the plurality of alternative CSI matrices and the plurality of third sample CSI matrices, first network parameters corresponding to a plurality of neural network layers included in a target encoding neural network and second network parameters corresponding to a plurality of neural network layers included in a target decoding neural network by training the initial encoding neural network and the initial decoding neural network by using the plurality of third sample CSI matrices as supervision;
where the initial encoding neural network is an untrained neural network having the same network structure as the target encoding neural network, and the initial decoding neural network is an untrained neural network having the same network structure as the target decoding neural network;
where the target encoding neural network includes a first multi-feature analysis network used for determining the first CSI matrix and a compression neural network used for compressing the first correlation feature matrix; and the target decoding neural network at least includes the second multi-feature analysis network and a recovery neural network used for recovering the target codeword to the second correlation feature matrix.

The specific implementation is similar to a manner in which training is performed on the base station side and will not be repeated here.

In some examples, the information feedback apparatus 1600 further includes:
a first sending module, configured to send first signaling to the terminal, the first signaling including the first network parameters.

In some examples, the information feedback apparatus 1600 further includes:
a second configuration module, configured to obtain, based on the second network parameters, the target decoding neural network by configuring network parameters corresponding to a plurality of neural network layers included in the initial decoding neural network pre-deployed on the base station.

In some examples, the information feedback apparatus 1600 further includes:
a second sending module, configured to send, when the first network parameters are updated, second signaling to the terminal, the second signaling including updated first network parameters.

In some examples, the information feedback apparatus 1600 further includes:
an update module, configured to obtain, when the second network parameters are updated, based on updated second network parameters, an updated target decoding neural network by updating network parameters corresponding to a plurality of neural network layers included in the target decoding neural network on the base station.

The specific implementation is similar to the implementation of the base station side obtaining the target decoding neural network by sending signaling and configuring, and the updating process of the target decoding neural network, which will not be repeated here.

Alternatively, the number of the second multi-feature analysis network is one or more, and when the number of the second multi-feature analysis networks is more than one, the plurality of second multi-feature analysis networks are connected in a cascade manner.

In some examples, the apparatus further includes:
a seventh determination module, configured to determine, based on the target CSI matrix, a fifth CSI matrix; where the fifth CSI matrix has a first number of non-zero rows of parameter values in an order from front to back, the first number of non-zero rows of parameter values are the same as a parameter value included in the target CSI matrix, and the first number is the same as the total number of the antennas deployed on the base station; and
an eighth determination module, configured to obtain a sixth CSI matrix by performing a two-dimensional inverse discrete Fourier transform on the fifth CSI matrix, the sixth CSI matrix being a matrix determined on a base station side and used for indicating different parameter values corresponding to different space domains and frequency domains when the terminal feeds the CSI by the antenna back to the base station.

The specific implementation is similar to the implementation of the base station side recasting the sixth CSI matrix and will not be repeated here.

As for the apparatus example, as it basically corresponds to the method examples, please refer to the partial description of the method examples for related parts. The apparatus example described above is merely illustrative. Units described as separate components may or may not be physically separated, and the components displayed as units may or may not be physical units, that is, they may be located in one place, or they may be distributed onto a plurality of network units. Some or all of modules may be selected according to actual needs to implement the objective of the scheme of the disclosure. Those of ordinary skill in the art may understand and implement it without creative work.

Correspondingly, the disclosure further provides a non-transitory computer readable storage medium. The storage medium stores a computer program, and the computer program is used for executing any above information feedback method used on the terminal side.

Correspondingly, the disclosure further provides a non-transitory computer readable storage medium. The storage medium stores a computer program, and the computer program is used to execute any of the above information feedback methods used on the terminal side.

Correspondingly, the disclosure further provides an information feedback apparatus, including:
a processor; and
a memory, configured to store a processor-executable instruction,
where the processor is configured to execute any above information feedback method on the terminal side.

FIG. 17 is a block diagram of an information feedback apparatus 1700 illustrated according to an example. For example, the apparatus 1700 may be a terminal such as a cell phone, a tablet computer, an e-book reader, a multimedia playback device, a wearable device, a vehicle user device, an ipad, and a smart TV.

Referring to FIG. 17, the apparatus 1700 may include one or more of the following components: a processing component 1702, a memory 1704, a power component 1706, a multimedia component 1708, an audio component 1710, an input/output (I/O) interface 1712, a sensor component 1716, and a communication component 1718.

The processing component 1702 typically controls the overall operation of the apparatus 1700, such as operations associated with display, a telephone call, data random access, a camera operation, and a recording operation. The processing component 1702 may include one or more processors 1720 to execute instructions to complete all or part of the steps of the above information feedback method. In addition, the processing component 1702 may include one or more modules to facilitate an interaction between the processing component 1702 and other components. For example, the processing component 1702 may include a multimedia module to facilitate an interaction between the multimedia component 1708 and the processing component 1702. For another example, the processing component 1702 may read an executable instruction from the memory to implement the steps of one information feedback methods provided in the above examples.

The memory 1704 is configured to store various types of data to support operations on the apparatus 1700. Examples of these data include instructions for any application or method operating on the apparatus 1700, contact data, phonebook data, messages, pictures, videos, etc.

The memory 1704 may be implemented by any type of volatile or nonvolatile storage device or their combination, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk.

The power component 1706 provides power for various components of the apparatus 1700. The power component 1706 may include a power management system, one or more power sources and other components associated with generating, managing and distributing power for the apparatus 1700.

The multimedia component 1708 includes a screen providing an output interface between the apparatus 1700 and a user. In some examples, the multimedia component 1708 includes a front camera and/or a rear camera. When the apparatus 1700 is in an operation mode, such as a shooting mode or a video mode, the front camera and/or the rear camera may receive external multimedia data. Each front camera and rear camera may be a fixed optical lens system or have a focal length and optical zoom capability.

The audio component 1710 is configured to output and/or input audio signals. For example, the audio component 1710 includes a microphone (MIC) configured to receive an external audio signal when the apparatus 1700 is in the operation mode, such as a call mode, a recording mode, and a speech recognition mode. The received audio signal may be further stored in the memory 1704 or transmitted via the communication component 1718. In some examples, the audio component 1710 further includes a speaker for outputting the audio signals.

The I/O interface 1712 provides an interface between the processing component 1702 and a peripheral interface module which may be a keyboard, a click wheel, a button, etc. These buttons may include but are not limited to: a home button, a volume button, a start button and a lock button.

The sensor component 1716 includes one or more sensors for providing state evaluation of various aspects for the apparatus 1700. For example, the sensor component 1716 may detect an on/off state of the apparatus 1700 and the relative positioning of the components, for example, the component is a display and a keypad of the apparatus 1700. The sensor component 1716 may also detect the change of the position of the apparatus 1700 or one component of the apparatus 1700, the presence or absence of user contact with the apparatus 1700, the azimuth or acceleration/deceleration of the apparatus 1700, and temperature change of the apparatus 1700. The sensor component 1716 may include a proximity sensor configured to detect the presence of nearby objects in the absence of any physical contact. The sensor component 1716 may further include an optical sensor, such as a CMOS or CCD image sensor, for use in imaging applications. In some examples, the sensor component 1716 may further include an acceleration sensor, a gyroscope sensor, a magnetic sensor, a pressure sensor, or a temperature sensor.

The communication component 1718 is configured to facilitate wired or wireless communication between the apparatus 1700 and other devices. The apparatus 1700 may access a wireless network based on a communication standard, such as Wi-Fi, 2G, 3G, 4G, 5G or 6G or their combination. In an example, the communication component 1718 receives a broadcast signal or broadcast-related information from an external broadcast management system via a broadcast channel. In an example, the communication component 1718 further includes a near field communication (NFC) module to facilitate short-range communication. For example, the NFC module may be implemented based on a radio frequency identification (RFID) technology, an infrared data association (IrDA) technology, an ultra wideband (UWB) technology, a Bluetooth (BT) technology and other technologies.

In an example, the apparatus 1700 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic elements for executing any above described information feedback method on the terminal side.

In an example, a non-transitory computer-readable storage medium including instructions, such as the memory 1704 including instructions, which may be executed by the processor 1720 of the apparatus 1700 to complete a terminal capability reporting method, is further provided. For example, the non-temporary computer-readable storage medium may be an ROM, a random access memory (RAM), a CD-ROM, a magnetic tape, a floppy disk, an optical data storage device, etc.

Correspondingly, the disclosure further provides an information feedback apparatus, including:
a processor; and
a memory, configured to store a processor-executable instruction,
where the processor is configured to execute any above information feedback method on a base station side.

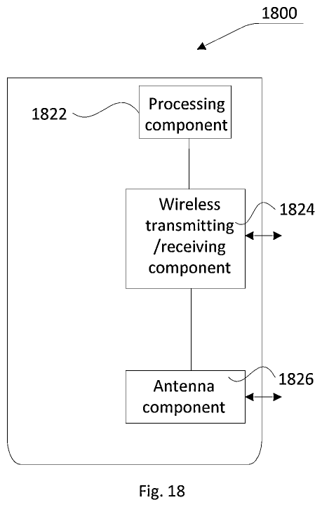

As shown in FIG. 18, FIG. 18 is a schematic structural diagram of an information feedback apparatus 1800 illustrated according to an example. The apparatus 1800 may be provided as a base station. Referring to FIG. 18, the apparatus 1800 includes a processing component 1822, a wireless transmitting/receiving component 1824, an antenna component 1826, and a signal processing part specific to a wireless interface, and the processing component 1822 may further include at least one processor.

One processor in the processing component 1822 may be configured to execute any above information feedback method.

According to a first aspect of the examples of the disclosure, an information feedback method is provided. The method is performed by a terminal and includes:
determining a first channel state information (CSI) matrix, the first CSI matrix being a matrix used for indicating different angle values corresponding to different feedback paths when a terminal feeds CSI by an antenna back to a base station;
obtaining a first correlation feature matrix outputted from a first multi-feature analysis network and used for indicating a correlation among a plurality of pieces of feature information of the CSI by inputting the first CSI matrix into the first multi-feature analysis network;
obtaining a target codeword corresponding to the CSI by compressing the first correlation feature matrix; and
feeding the target codeword back to the base station by the antenna.

Alternatively, determining the first channel state information (CSI) matrix includes:
determining a second CSI matrix, the second CSI matrix being a matrix used for indicating different parameter values corresponding to different space domains and frequency domains when the terminal feeds the CSI by the antenna back to the base station;
obtaining a third CSI matrix by performing a two-dimensional discrete Fourier transform on the second CSI matrix; and
obtaining the first CSI matrix by retaining a first number of non-zero rows of parameter values in an order from front to back in the third CSI matrix, the first number being the same as a total number of antennas deployed at the base station.

Alternatively, the plurality of pieces of feature information of the CSI at least include spatial feature information of the CSI and channel feature information of the CSI.

The first multi-feature analysis network determines the first correlation feature matrix by adopting the following manner:
determining, based on the first CSI matrix, a first spatial feature matrix used for indicating the spatial feature information of the CSI;
determining, based on the first CSI matrix, a first channel feature matrix used for indicating the channel feature information of the CSI;
obtaining a first fused feature matrix by fusing the first spatial feature matrix and the first channel feature matrix by column; and
obtaining the first correlation feature matrix outputted from a first composite convolutional layer by inputting the first fused feature matrix into the first composite convolutional layer, the first composite convolutional layer being obtained by compositing a first convolutional layer with at least one other neural network layer.

Alternatively, a size of convolutional kernels of the first convolutional layer is 1×1, and the number of the convolutional kernels of the first convolutional layer is the same as the number of channels inputted into the first composite convolutional layer.

Alternatively, determining, based on the first CSI matrix, the first spatial feature matrix used for indicating the spatial feature information of the CSI includes:
obtaining the first spatial feature matrix outputted from a second number of second composite convolutional layers by inputting a real portion and an imaginary portion of the first CSI matrix into the second number of second composite convolutional layers, each second composite convolutional layer being obtained by compositing a second convolutional layer with at least one other neural network layer.

Alternatively, sizes of convolutional kernels of at least two second convolutional layers are different, and the number of the convolutional kernels of each second convolutional layer is the same as the number of channels inputted into each second composite convolutional layer.

Alternatively, determining, based on the first CSI matrix, the first channel feature matrix used for indicating the channel feature information of the CSI includes:
determining, based on the first CSI matrix, a first feature matrix used for indicating average global channel feature information of the CSI, and a second feature matrix used for indicating maximum global channel feature information of the CSI;
determining a fused third feature matrix by performing a weighted fusion on the first feature matrix and the second feature matrix; and
determining, based on the third feature matrix and the first CSI matrix, the first channel feature matrix.

Alternatively, determining, based on the first CSI matrix, the first feature matrix used for indicating the average global channel feature information of the CSI, and the second feature matrix used for indicating the maximum global channel feature information of the CSI includes:
obtaining the first feature matrix outputted from a first composite layer by inputting the real portion and the imaginary portion of the first CSI matrix into the first composite layer, the first composite layer being obtained by at least compositing an average pooling layer with a third number of first fully connected layers; and
obtaining the second feature matrix outputted from a second composite layer by inputting the real portion and the imaginary portion of the first CSI matrix into the second composite layer, the second composite layer being obtained by at least compositing a maximum pooling layer with a third number of second fully connected layers.

Alternatively, network parameters corresponding to the third number of first fully connected layers are the same as network parameters corresponding to the third number of second fully connected layers.

Alternatively, obtaining the target codeword corresponding to the CSI by compressing the first correlation feature matrix includes:
obtaining a first correlation feature vector by performing a dimensionality reduction on the first correlation feature matrix; and
obtaining the target codeword by compressing the first correlation feature vector according to a preset compression rate.

Alternatively, the method further includes:
receiving first signaling sent by the base station; where the first signaling includes first network parameters corresponding to a plurality of neural network layers included in a target encoding neural network, and the target encoding neural network includes the first multi-feature analysis network and a compression neural network used for compressing the first correlation feature matrix; and
obtaining the target encoding neural network by configuring, based on the first network parameters, network parameters corresponding to a plurality of neural network layers included in an initial encoding neural network pre-deployed on the terminal; where the initial encoding neural network is an untrained neural network having the same network structure as the target encoding neural network.

Alternatively, the method further includes:
receiving second signaling sent by the base station; where the second signaling includes updated first network parameters corresponding to the plurality of neural network layers included in the target encoding neural network, and the target encoding neural network includes the first multi-feature analysis network and the compression neural network used for compressing the first correlation feature matrix; and
obtaining an updated target encoding neural network by updating, based on the updated first network parameters, the network parameters corresponding to the plurality of neural network layers included in the target encoding neural network.

According to a second aspect of the examples of the disclosure, an information feedback method is provided. The method is performed by a base station and includes:
receiving a target codeword corresponding to channel state information (CSI) and fed back by a terminal;
recovering the target codeword to a second correlation feature matrix having the same dimension as a first correlation feature matrix, the first correlation feature matrix being a matrix used for indicating a correlation among a plurality of pieces of feature information of the CSI; and
determining a target CSI matrix based on an output result of a second multi-feature analysis network by inputting the second correlation feature matrix into the second multi-feature analysis network;
where the target CSI matrix is a matrix, determined by the base station, of different angle values corresponding to different feedback paths when the terminal feeds the CSI by an antenna back to the base station.

Alternatively, recovering the target codeword to the second correlation feature matrix having the same dimension as the first correlation feature matrix includes:
obtaining a second correlation feature vector by amplifying the target codeword based on a preset compression rate; and
obtaining the second correlation feature matrix by performing a dimensionality increase on the second correlation feature vector.

Alternatively, the method further includes:
obtaining an expanded second correlation feature matrix by expanding the number of channels of the second correlation feature matrix.

Determining, based on the output result of the second multi-feature analysis network, the target CSI matrix by inputting the second correlation feature matrix into the second multi-feature analysis network includes:
obtaining a fourth CSI matrix outputted from the second multi-feature analysis network by inputting the expanded second correlation feature matrix into the second multi-feature analysis network; and
obtaining the target CSI matrix by reducing the number of channels of the fourth CSI matrix.

Alternatively, obtaining the expanded second correlation feature matrix by expanding the number of channels of the second correlation feature matrix includes:
obtaining the expanded second correlation feature matrix outputted from a third composite convolutional layer by inputting the second correlation feature matrix into the third composite convolutional layer, the third composite convolutional layer being obtained by at least compositing a third convolutional layer with at least one other neural network layer.

Alternatively, the number of convolutional kernels of the third convolutional layer is the same as the number of channels of the expanded second correlation feature matrix.

Alternatively, the plurality of pieces of feature information of the CSI at least include spatial feature information of the CSI and channel feature information of the CSI.

The second multi-feature analysis network determines the fourth CSI matrix by adopting the following manner:
determining, based on the expanded second correlation feature matrix, a second spatial feature matrix used for indicating the spatial feature information of the CSI;
determining, based on the expanded second correlation feature matrix, a second channel feature matrix used for indicating the channel feature information of the CSI;
obtaining a second fused feature matrix by fusing the second spatial feature matrix and the second channel feature matrix by column; and
obtaining the second correlation feature matrix outputted from a fourth composite convolutional layer by inputting the second fused feature matrix into the fourth composite convolutional layer, the fourth composite convolutional layer being obtained by compositing a fourth convolutional layer with at least one other neural network layer.

Alternatively, a size of a convolutional kernel of the fourth convolutional layer is 1×1, and the number of the convolutional kernels of the fourth convolutional layer is the same as the number of channels inputted into the fourth composite convolutional layer.

Alternatively, determining, based on the expanded second correlation feature matrix, the second spatial feature matrix used for indicating the spatial feature information of the CSI includes:
obtaining the second spatial feature matrix outputted from a fourth number of fifth composite convolutional layers by inputting the expanded second correlation feature matrix into the fourth number of fifth composite convolutional layers, the fifth composite convolutional layer being obtained by compositing a fifth convolutional layer with at least one other neural network layer.

Alternatively, sizes of convolutional kernels of at least two fifth convolutional layers are different, and the number of the convolutional kernels of each fifth convolutional layer is the same as the number of channels inputted into each fifth composite convolutional layer.

Alternatively, determining, based on the expanded second correlation feature matrix, the second channel feature matrix used for indicating the channel feature information of the CSI includes:
determining, based on the expanded second correlation feature matrix, a fourth feature matrix used for indicating average global channel feature information of the CSI, and a fifth feature matrix used for indicating maximum global channel feature information of the CSI;
determining a fused sixth feature matrix by performing a weighted fusion on the fourth feature matrix and the fifth feature matrix; and
determining, based on the sixth feature matrix and the second correlation feature matrix, the second channel feature matrix.

Alternatively, determining, based on the expanded second correlation feature matrix, the fourth feature matrix used for indicating the average global channel feature information of the CSI, and the fifth feature matrix used for indicating the maximum global channel feature information of the CSI includes:
obtaining the fourth feature matrix outputted from a third composite layer by inputting the expanded second correlation feature matrix into the third composite layer, the third composite layer being obtained by at least compositing an average pooling layer with a fifth number of third fully connected layers; and
obtaining the fifth feature matrix outputted from a fourth composite layer by inputting the expanded second correlation feature matrix into the fourth composite layer, the fourth composite layer being obtained by at least compositing a maximum pooling layer with a fifth number of fourth fully connected layers.

Alternatively, network parameters corresponding to the fifth number of third fully connected layers are the same as network parameters corresponding to the fifth number of fourth fully connected layers.

Alternatively, obtaining the target CSI matrix by reducing the number of the channels of the fourth CSI matrix includes:
obtaining the target CSI matrix by reducing the number of the channels of the fourth CSI matrix to a sixth number by a sixth composite convolutional layer and a nonlinear activation function layer; where the sixth composite convolutional layer is obtained by compositing a sixth convolutional layer with at least one other neural network layer, and the sixth number is the same as the number of channels corresponding to the first CSI matrix.

Alternatively, a size of a convolutional kernel of the sixth convolutional layer is 1×1, and the number of the convolutional kernels of the sixth convolutional layer is the same as the sixth number.

Alternatively, the method further includes:
obtaining a plurality of first sample CSI matrices, the first sample CSI matrices being matrices used for indicating different sample parameter values corresponding to different space domains and frequency domains when the terminal feeds the CSI by the antenna back to the base station;
obtaining a plurality of second sample CSI matrices by performing a two-dimensional discrete Fourier transform on the plurality of the first sample CSI matrices;
obtaining the plurality of third sample CSI matrices by retaining a first number of non-zero rows of parameter values in an order from front to back in the plurality of second sample CSI matrices, the first number being the same as a total number of antennas deployed at the base station;
determining, based on an output result of an initial decoding neural network, a plurality of alternative CSI matrices by inputting the plurality of third sample CSI matrices into an initial encoding neural network, the initial encoding neural network being connected to the initial decoding neural network through an analog channel; and
determining, at a minimum difference between the plurality of alternative CSI matrices and the plurality of third sample CSI matrices, first network parameters corresponding to a plurality of neural network layers included in a target encoding neural network and second network parameters corresponding to a plurality of neural network layers included in a target decoding neural network by training the initial encoding neural network and the initial decoding neural network by using the plurality of third sample CSI matrices as supervision;
where the initial encoding neural network is an untrained neural network having the same network structure as the target encoding neural network, and the initial decoding neural network is an untrained neural network having the same network structure as the target decoding neural network;
where the target encoding neural network includes a first multi-feature analysis network used for determining the first CSI matrix and a compression neural network used for compressing the first correlation feature matrix; and the target decoding neural network at least includes the second multi-feature analysis network and a recovery neural network used for recovering the target codeword to the second correlation feature matrix.

Alternatively, the method further includes:
sending first signaling to the terminal, the first signaling including the first network parameters.

Alternatively, the method further includes:
obtaining, based on the second network parameters, the target decoding neural network by configuring network parameters corresponding to a plurality of neural network layers included in the initial decoding neural network pre-deployed on the base station.

Alternatively, the method further includes:
sending, when the first network parameters are updated, second signaling to the terminal, the second signaling including updated first network parameters.

Alternatively, the method further includes:
obtaining, when the second network parameters are updated and based on updated second network parameters, an updated target decoding neural network by updating network parameters corresponding to a plurality of neural network layers included in the target decoding neural network on the base station.

Alternatively, the number of the second multi-feature analysis network is one or more, and when the number of the second multi-feature analysis networks is more than one, the plurality of second multi-feature analysis networks are connected in a cascade manner.

Alternatively, the method further includes:
determining, based on the target CSI matrix, a fifth CSI matrix; where the fifth CSI matrix has a first number of non-zero rows of parameter values in an order from front to back, the first number of non-zero rows of parameter values are the same as a parameter value included in the target CSI, and the first number is the same as the total number of the antennas deployed at the base station; and
obtaining a sixth CSI matrix by performing a two-dimensional inverse discrete Fourier transform on the fifth CSI matrix, the sixth CSI matrix being a matrix determined at a base station side and used for indicating different parameter values corresponding to different space domains and frequency domains when the terminal feeds the CSI by the antenna back to the base station.

According to a third aspect of the examples of the disclosure, an information feedback apparatus is provided. The apparatus is performed by a terminal, and includes:
a first determination module, configured to determine a first channel state information (CSI) matrix, the first CSI matrix being a matrix used for indicating different angle values corresponding to different feedback paths when the terminal feeds CSI by an antenna back to a base station;
a first execution module, configured to obtain a first correlation feature matrix outputted from a first multi-feature analysis network and used for indicating a correlation among a plurality of pieces of feature information of the CSI by inputting the first CSI matrix into the first multi-feature analysis network;
a compression module, configured to obtain a target codeword corresponding to the CSI by compressing the first correlation feature matrix; and
a feedback module, configured to feed the target codeword back to the base station by the antenna.

According to a fourth aspect of the examples of the disclosure, an information feedback apparatus is provided. The apparatus is performed by a base station, and includes:
a first reception module, configured to receive a target codeword corresponding to channel state information (CSI) and fed back by a terminal;
a recovery module, configured to recover the target codeword to a second correlation feature matrix having the same dimension as a first correlation feature matrix, the first correlation feature matrix being a matrix used for indicating a correlation among a plurality of pieces of feature information of the CSI; and
a second execution module, configured to determine, based on an output result of a second multi-feature analysis network, a target CSI matrix by inputting the second correlation feature matrix into the second multi-feature analysis network;
where the target CSI matrix is a matrix, determined by a base station, of different angle values corresponding to different feedback paths when the terminal feeds the CSI by an antenna back to the base station.
where the processor is configured to execute any above information feedback method at a base station side.

A technical solution provided by the examples of the disclosure may include the following beneficial effects:
in the examples of the disclosure, a CSI structure can be fully utilized, CSI feedback is performed based on the correlation among the feature information of a plurality of dimensions, such that the precision of compression feedback is improved, and the accuracy of CSI reconstruction by the base station side is improved.

Those of skill in the art will easily think of other implementation schemes of the disclosure after considering the specification and practicing the disclosure here. The disclosure is intended to cover any variations, uses, or adaptations of the disclosure, and these variations, uses, or adaptations follow the general principles of the disclosure and include common knowledge or customary technical means in the technical field not disclosed in the disclosure. The description and examples are considered as examples merely, and the true scope and spirit of the disclosure is indicated by the following claims.

It is to be understood that the disclosure is not limited to an exact structure that has been described above and illustrated in the accompanying drawings, and that various modifications and changes may be made without departing from its scope. The scope of the disclosure is merely limited by the appended claims.

1. An information feedback method, wherein the method is performed by a terminal, and comprises:
determining a first channel state information (CSI) matrix, the first CSI matrix being a matrix used for indicating different angle values corresponding to different feedback paths when the terminal feeds CSI by an antenna back to a base station;
obtaining a first correlation feature matrix outputted from a first multi-feature analysis network and used for indicating a correlation among a plurality of pieces of feature information of the CSI by inputting the first CSI matrix into the first multi-feature analysis network;
obtaining a target codeword corresponding to the CSI by compressing the first correlation feature matrix; and
feeding the target codeword back to the base station by the antenna.

2. The method according to claim 1, wherein determining the first channel state information (CSI) matrix comprises:
determining a second CSI matrix, the second CSI matrix being a matrix used for indicating different parameter values corresponding to different space domains and frequency domains when the terminal feeds the CSI by the antenna back to the base station;
obtaining a third CSI matrix by performing a two-dimensional discrete Fourier transform on the second CSI matrix; and
obtaining the first CSI matrix by retaining a first number of non-zero rows of parameter values in an order from front to back in the third CSI matrix, the first number being a same as a total number of antennas deployed at the base station.

3. The method according to claim 1, wherein the plurality of pieces of feature information of the CSI at least comprise spatial feature information of the CSI and channel feature information of the CSI; and
the first multi-feature analysis network determines the first correlation feature matrix by:
determining, based on the first CSI matrix, a first spatial feature matrix used for indicating the spatial feature information of the CSI;
determining, based on the first CSI matrix, a first channel feature matrix used for indicating the channel feature information of the CSI;
obtaining a first fused feature matrix by fusing the first spatial feature matrix and the first channel feature matrix by column; and
obtaining the first correlation feature matrix outputted from a first composite convolutional layer by inputting the first fused feature matrix into the first composite convolutional layer, the first composite convolutional layer being obtained by compositing a first convolutional layer with at least one other neural network layer, wherein a size of a convolutional kernel of the first convolutional layer is 1×1, and the number of the convolutional kernels of the first convolutional layer is a same as the number of channels inputted into the first composite convolutional layer.

4. (canceled)

5. The method according to claim 3, wherein determining, based on the first CSI matrix, the first spatial feature matrix used for indicating the spatial feature information of the CSI comprises:
obtaining the first spatial feature matrix outputted from a second number of second composite convolutional layers by inputting a real portion and an imaginary portion of the first CSI matrix into the second number of second composite convolutional layers, each second composite convolutional layer being obtained by compositing a second convolutional layer with at least one other neural network layer, wherein sizes of convolutional kernels of at least two second convolutional layers are different, and the number of the convolutional kernels of each second convolutional layer is a same as the number of channels inputted into each second composite convolutional layer.

6. (canceled)

7. The method according to claim 3, wherein determining, based on the first CSI matrix, the first channel feature matrix used for indicating the channel feature information of the CSI comprises:
determining, based on the first CSI matrix, a first feature matrix used for indicating average global channel feature information of the CSI, and a second feature matrix used for indicating maximum global channel feature information of the CSI;
determining a fused third feature matrix by performing a weighted fusion on the first feature matrix and the second feature matrix; and
determining, based on the third feature matrix and the first CSI matrix, the first channel feature matrix.

8. The method according to claim 7, wherein determining, based on the first CSI matrix, the first feature matrix used for indicating the average global channel feature information of the CSI, and the second feature matrix used for indicating the maximum global channel feature information of the CSI comprises:
obtaining the first feature matrix outputted from a first composite layer by inputting real portion and imaginary portion of the first CSI matrix into the first composite layer, the first composite layer being obtained by at least compositing an average pooling layer with a third number of first fully connected layers;
obtaining the second feature matrix outputted from a second composite layer by inputting the real portion and the imaginary portion of the first CSI matrix into the second composite layer, the second composite layer being obtained by at least compositing a maximum pooling layer with a third number of second fully connected layers; and
wherein network parameters corresponding to the third number of first fully connected layers are a same as network parameters corresponding to the third number of second fully connected layers.

9. (canceled)

10. The method according to claim 1, wherein obtaining the target codeword corresponding to the CSI by compressing the first correlation feature matrix comprises:
obtaining a first correlation feature vector by performing a dimensionality reduction on the first correlation feature matrix; and
obtaining the target codeword by compressing the first correlation feature vector according to a preset compression rate.

11. The method according to claim 1, further comprising:
receiving first signaling sent by the base station; wherein the first signaling comprises first network parameters corresponding to a plurality of neural network layers comprised in a target encoding neural network, and the target encoding neural network comprises the first multi-feature analysis network and a compression neural network used for compressing the first correlation feature matrix; and
obtaining the target encoding neural network by configuring, based on the first network parameters, network parameters corresponding to a plurality of neural network layers comprised in an initial encoding neural network pre-deployed on the terminal; wherein the initial encoding neural network is an untrained neural network having the same network structure as the target encoding neural network.

12. The method according to claim 1, further comprising:
receiving second signaling sent by the base station; wherein the second signaling comprises updated first network parameters corresponding to the plurality of the neural network layers comprised in the target encoding neural network, and the target encoding neural network comprises the first multi-feature analysis network and the compression neural network used for compressing the first correlation feature matrix; and
obtaining an updated target encoding neural network by updating, based on the updated first network parameters, the network parameters corresponding to the plurality of the neural network layers comprised in the target encoding neural network.

13. An information feedback method, wherein the method is performed by a base station, and comprises:
receiving a target codeword corresponding to channel state information (CSI) and fed back by a terminal;
recovering the target codeword to a second correlation feature matrix having the same dimension as a first correlation feature matrix, the first correlation feature matrix being a matrix used for indicating a correlation among a plurality of pieces of feature information of the CSI; and
determining a target CSI matrix based on an output result of a second multi-feature analysis network by inputting the second correlation feature matrix into the second multi-feature analysis network;
wherein the target CSI matrix is a matrix, determined by a base station, of different angle values corresponding to different feedback paths when the terminal feeds the CSI by an antenna back to the base station.

14. The method according to claim 13, wherein recovering the target codeword to the second correlation feature matrix having the same dimension as the first correlation feature matrix comprises:
obtaining a second correlation feature vector by amplifying the target codeword based on a preset compression rate; and
obtaining the second correlation feature matrix by performing a dimensionality increase on the second correlation feature vector.

15. The method according to claim 13, further comprising:
obtaining an expanded second correlation feature matrix by expanding the number of channels of the second correlation feature matrix;
wherein determining, based on the output result of the second multi-feature analysis network, the target CSI matrix by inputting the second correlation feature matrix into the second multi-feature analysis network comprises:
obtaining a fourth CSI matrix outputted from the second multi-feature analysis network by inputting the expanded second correlation feature matrix into the second multi-feature analysis network;
obtaining the target CSI matrix by reducing the number of channels of the fourth CSI matrix; and
wherein obtaining the expanded second correlation feature matrix by expanding the number of the channels of the second correlation feature matrix comprises:
obtaining the expanded second correlation feature matrix outputted from a third composite convolutional layer by inputting the second correlation feature matrix into the third composite convolutional layer, the third composite convolutional layer being obtained by at least compositing a third convolutional layer with at least one other neural network layer, wherein the number of convolutional kernels of the third convolutional layer is a same as the number of channels of the expanded second correlation feature matrix.

16.-17. (canceled)

18. The method according to claim 15, wherein the plurality of pieces of feature information of the CSI at least comprise spatial feature information of the CSI and channel feature information of the CSI; and
the second multi-feature analysis network determines the fourth CSI matrix by:
determining, based on the expanded second correlation feature matrix, a second spatial feature matrix used for indicating the spatial feature information of the CSI;
determining, based on the expanded second correlation feature matrix, a second channel feature matrix used for indicating the channel feature information of the CSI;
obtaining a second fused feature matrix by fusing the second spatial feature matrix and the second channel feature matrix by column;
obtaining the second correlation feature matrix outputted from a fourth composite convolutional layer by inputting the second fused feature matrix into the fourth composite convolutional layer, the fourth composite convolutional layer being obtained by compositing a fourth convolutional layer with at least one other neural network layer, wherein a size of a convolutional kernel of the fourth convolutional layer is 1×1, and the number of the convolutional kernels of the fourth convolutional layer is the same as the number of channels inputted into the fourth composite convolutional layer;
wherein determining, based on the expanded second correlation feature matrix, the second spatial feature matrix used for indicating the spatial feature information of the CSI comprises:
obtaining the second spatial feature matrix outputted from a fourth number of fifth composite convolutional layers by inputting the expanded second correlation feature matrix into the fourth number of fifth composite convolutional layers, the fifth composite convolutional layer being obtained by compositing a fifth convolutional layer with at least one other neural network layer, wherein sizes of convolutional kernels of at least two fifth convolutional layers are different, and the number of the convolutional kernels of each fifth convolutional layer is a same as the number of channels inputted into each fifth composite convolutional layer;
wherein determining, based on the expanded second correlation feature matrix, the second channel feature matrix used for indicating the channel feature information of the CSI comprises:
determining, based on the expanded second correlation feature matrix, a fourth feature matrix used for indicating average global channel feature information of the CSI, and a fifth feature matrix used for indicating maximum global channel feature information of the CSI;
determining a fused sixth feature matrix by performing a weighted fusion on the fourth feature matrix and the fifth feature matrix; and
determining, based on the sixth feature matrix and the second correlation feature matrix, the second channel feature matrix;
wherein determining, based on the expanded second correlation feature matrix, the fourth feature matrix used for indicating the average global channel feature information of the CSI, and the fifth feature matrix used for indicating the maximum global channel feature information of the CSI comprises:
obtaining the fourth feature matrix outputted from a third composite layer by inputting the expanded second correlation feature matrix into the third composite layer, the third composite layer being obtained by at least compositing an average pooling layer with a fifth number of third fully connected layers; and
obtaining the fifth feature matrix outputted from a fourth composite layer by inputting the expanded second correlation feature matrix into the fourth composite layer, the fourth composite layer being obtained by at least compositing a maximum pooling layer with a fifth number of fourth fully connected layers, wherein network parameters corresponding to the fifth number of third fully connected layers are same as network parameters corresponding to the fifth number of fourth fully connected layers.

19.-24. (canceled)

25. The method according to claim 15, wherein obtaining the target CSI matrix by reducing the number of the channels of the fourth CSI matrix comprises:
obtaining the target CSI matrix by reducing the number of the channels of the fourth CSI matrix to a sixth number by a sixth composite convolutional layer and a nonlinear activation function layer; wherein the sixth composite convolutional layer is obtained by compositing a sixth convolutional layer with at least one other neural network layer, and the sixth number is a same as the number of channels corresponding to the first CSI matrix, wherein a size of a convolutional kernel of the sixth convolutional layer is 1×1, and the number of the convolutional kernels of the sixth convolutional layer is a same as the sixth number.

26. (canceled)

27. The method according to claim 13, further comprising:
obtaining a plurality of first sample CSI matrices, the first sample CSI matrices being matrices used for indicating different sample parameter values corresponding to different space domains and frequency domains when the terminal feeds the CSI by the antenna back to the base station;
obtaining a plurality of second sample CSI matrices by performing a two-dimensional discrete Fourier transform on the plurality of the first sample CSI matrices;
obtaining a plurality of third sample CSI matrices by retaining a first number of non-zero rows of parameter values in an order from front to back in the plurality of second sample CSI matrices, the first number being a same as a total number of antennas deployed at the base station;
determining, based on an output result of an initial decoding neural network, a plurality of alternative CSI matrices by inputting the plurality of third sample CSI matrices into an initial encoding neural network, the initial encoding neural network being connected to the initial decoding neural network through an analog channel;
determining, at a minimum difference between the plurality of alternative CSI matrices and the plurality of third sample CSI matrices, first network parameters corresponding to a plurality of neural network layers comprised in a target encoding neural network and second network parameters corresponding to a plurality of neural network layers comprised in a target decoding neural network by training the initial encoding neural network and the initial decoding neural network by using the plurality of third sample CSI matrices as supervision;
wherein the initial encoding neural network is an untrained neural network having the same network structure as the target encoding neural network, and the initial decoding neural network is an untrained neural network having the same network structure as the target decoding neural network;
wherein the target encoding neural network comprises a first multi-feature analysis network used for determining the first CSI matrix and a compression neural network used for compressing the first correlation feature matrix; and the target decoding neural network at least comprises the second multi-feature analysis network and a recovery neural network used for recovering the target codeword to the second correlation feature matrix.

28. The method according to claim 27, further comprising at least one:
sending first signaling to the terminal, the first signaling comprising the first network parameters;
obtaining, based on the second network parameters, the target decoding neural network by configurinq network parameters corresponding to a plurality of neural network layers comprised in the initial decodinq neural network pre-deployed on the base station;
sending, when the first network parameters are updated, second signaling to the terminal, the second signaling comprising updated first network parameters; or
obtaining, when the second network parameters are updated and based on updated second network parameters, an updated target decoding neural network by updating network parameters corresponding to a plurality of neural network layers comprised in the target decodinq neural network on the base station.

29.-31. (canceled)

32. The method according to claim 13, wherein the number of the second multi-feature analysis network is one or more, and when the number of the second multi-feature analysis networks is more than one, the plurality of second multi-feature analysis networks are connected in a cascade manner.

33. The method according to claim 13, further comprising:
determining, based on the target CSI matrix, a fifth CSI matrix; wherein the fifth CSI matrix has a first number of non-zero rows of parameter values in an order from front to back, the first number of non-zero rows of parameter values are same as a parameter value comprised in the target CSI matrix, and the first number is a same as the total number of the antennas deployed at the base station; and
obtaining a sixth CSI matrix by performing a two-dimensional inverse discrete Fourier transform on the fifth CSI matrix, the sixth CSI matrix being a matrix determined at a base station side and used for indicating different parameter values corresponding to different space domains and frequency domains when the terminal feeds the CSI by the antenna back to the base station.

34.-37. (canceled)

38. An information feedback apparatus, comprising:
a processor; and
a memory, configured to store a processor-executable instruction,
wherein the processor is configured to:
determine a first channel state information (CSI) matrix, the first CSI matrix being a matrix used for indicating different angle values corresponding to different feedback paths when a terminal feeds CSI by an antenna back to a base station;
obtain a first correlation feature matrix outputted from a first multi-feature analysis network and used for indicating a correlation among a plurality of pieces of feature information of the CSI by inputting the first CSI matrix into the first multi-feature analysis network;
obtain a target codeword corresponding to the CSI by compressing the first correlation feature matrix; and
feed the target codeword back to the base station by the antenna.

39. An information feedback apparatus, comprising:
a processor; and
a memory, configured to store a processor-executable instruction,
wherein the processor is configured to implement the information feedback method according to claim 13.
